(19) United States
(12) Patent Application Publication
(10) Pub. No.: US 2011/0175874 A1
(43) Pub. Date: Jul. 21, 2011

(54) Display Device And Method For Driving The Same

(75) Inventors: Kenichi Wakimoto, Atsugi (JP); Masahiko Hayakawa, Atsugi (JP)

(73) Assignee: SEMICONDUCTOR ENERGY LABORATORY CO., LTD., Atsugi-shi (JP)

(21) Appl. No.: 13/006,689

(22) Filed: Jan. 14, 2011

(30) Foreign Application Priority Data
Jan. 20, 2010 (JP) 2010-010473

(51) Int. Cl. G09G 5/00; G09G 3/36

(52) U.S. Cl. 345/207; 345/87

(57) ABSTRACT

A liquid crystal display device includes an optical sensor provided near an end portion of a liquid crystal display panel, a pixel provided in a display region of the liquid crystal panel, and a monitoring pixel. The optical sensor detects illuminance of light delivered from the liquid crystal display panel side. The pixel for which a transistor whose off-state current is low and the monitoring pixel are supplied with a potential to display a still image, at least light transmitted through a liquid crystal layer of the monitoring pixel is detected by the optical sensor, and the pixel in the display region of the liquid crystal display panel and the monitoring pixel are supplied again with a potential when a rate of change in illuminance reaches a predetermined value, so that the still image is kept being displayed.

### TECHNICAL FIELD

The present invention relates to a display device that can display a still image and a method for driving the display device.

### BACKGROUND ART

An active matrix display device in which a plurality of pixels are arranged in matrix and a display element and a switching transistor connected to the display element are provided for each pixel has been known.

Further, an active matrix display device in which transistors each including a metal oxide that serves as a channel formation region are used as switching elements connected to pixel electrodes has attracted attention (Patent Document 1 and Patent Document 2).

Examples of a display element that can be applied to an active matrix display device include a liquid crystal element and electronic ink in which an electrophoretic method or the like is used. An active matrix liquid crystal display device to which a liquid crystal element is applied utilizes characteristics such as an excellent gray scale and high-speed operation of a liquid crystal element, so that it has been widely used for display application of a moving image or a still image.

Most electronic inks have a property of holding a display image even after the supply of electric power is stopped, that is, they are display elements having a so-called memory property. Thus, an active matrix display device to which electronic ink is applied has characteristics of extremely low power consumption.

### REFERENCE

### Patent Document

[Patent Document 1] Japanese Published Patent Application No. 2007-123861
[Patent Document 2] Japanese Published Patent Application No. 2007-096055

### DISCLOSURE OF INVENTION

For a switching transistor included in a conventional active matrix display device, a silicon-based material that causes high off-state current is used, so that a signal which is written to a pixel leaks through the transistor and is lost even when the transistor is in an off state. Therefore, in the case where a display element does not have a memory property, a signal needs to be written frequently in a conventional active matrix display device even when the same image is displayed, and it has been difficult to reduce power consumption.

Further, most display elements having a memory property operate at low speed, and cannot follow switching transistors provided for pixels when the switching transistors operate at high speed; thus, it has been difficult to display a moving image and express an excellent gray scale.

The present invention is made in view of the foregoing technical background. An object of the present invention is to provide a liquid crystal display device with low power consumption that can display a moving image and express an excellent gray scale, that has a structure by which the number of times of performing writing to a pixel is reduced when a still image is displayed, and that has a means for determining the timing of performing writing.

One embodiment of the present invention is a display device in which rewriting of a pixel potential for keeping display is performed at the timing determined by an optical sensor in a method for displaying a still image of a liquid crystal display device, and a method for driving the display device.

One embodiment of the present invention disclosed in this specification is a display device which includes a liquid crystal display panel; a display control circuit electrically connected to a driver circuit of the liquid crystal display panel; a backlight portion electrically connected to the display control circuit; a monitoring pixel performing display for an illuminance monitor provided for the liquid crystal display panel; and an optical sensor electrically connected to the display control circuit. The optical sensor is provided so as to detect light transmitted through a liquid crystal layer of the monitoring pixel.

Another embodiment of the present invention disclosed in this specification is a display device which includes a liquid crystal display panel; a display control circuit electrically connected to a driver circuit of the liquid crystal display panel; a monitoring pixel performing display for an illuminance monitor provided for the liquid crystal display panel; and an optical sensor electrically connected to the display control circuit. The optical sensor is provided so as to detect light reflected by the monitoring pixel.

The optical sensor has sensitivity to light in the visible-light wavelength range, and preferably has peak sensitivity thereto.

The monitoring pixel performing display for the illuminance monitor is formed outside a display region, and the optical sensor is provided in a traveling direction of light transmitted through or reflected by the monitoring pixel. With such a structure, detection sensitivity of the optical sensor can be improved. At this time, light may enter the optical sensor through a light guide plate.

Another embodiment of the present invention disclosed in this specification is a method for driving a display device, which includes the steps of supplying a pixel in a display region of a liquid crystal display panel with a potential to display a still image; supplying a monitoring pixel of the liquid crystal display panel with a potential to display a still image; detecting at least light transmitted through a liquid crystal layer of the monitoring pixel from a backlight by an optical sensor; and supplying again the pixel in the display region of the liquid crystal display panel and the monitoring pixel with a potential when a rate of change in illuminance of light detected by the optical sensor reaches a predetermined value, so that the still image is kept being displayed.

Another embodiment of the present invention disclosed in this specification is a method for driving a display device, which includes the steps of supplying a pixel in a display region of a liquid crystal display panel with a potential to display a still image; supplying a monitoring pixel of the liquid crystal display panel with a potential to display a still image; detecting light from the outside of the liquid crystal display panel by a first optical sensor; detecting at least light transmitted through a liquid crystal layer of the monitoring pixel from the outside of the liquid crystal display panel and reflected by an inside portion of the liquid crystal display panel by a second optical sensor; and calculating a rate of change in illuminance of reflected light due to a reduction in pixel potential of the liquid crystal display panel from a difference between a rate of change in illuminance of light detected by the first optical sensor and a rate of change in illuminance of reflected light detected by the second optical sensor, and supplying again the pixel in the display region of the liquid crystal display panel and the monitoring pixel with a potential when the rate of change in illuminance of reflected light due to the reduction in pixel potential of the liquid crystal display panel sensor reaches a predetermined value, so that the still image is kept being displayed.

In the above method for driving a display device, it is preferable that the pixel potential be gradually increased when the potential is rewritten to the pixel so that the quality of the image is not rapidly but gradually recovered.

A liquid crystal display device with low power consumption that has a structure by which the number of times of performing writing to a pixel is reduced when a still image is displayed, and that has a means for determining the timing of performing writing can be provided.

### BRIEF DESCRIPTION OF DRAWINGS

FIG. 1 is a block diagram illustrating a liquid crystal display device.

FIGS. 2A to 2C each illustrate a positional relationship between a liquid crystal display device and an optical sensor.

FIG. 3 illustrates an example of an equivalent circuit of a pixel in a liquid crystal display device.

FIG. 4 illustrates operation of a liquid crystal display device.

FIGS. 5A and 5B illustrate operation of a liquid crystal display device.

FIG. 6 illustrates operation of a liquid crystal display device.

FIG. 7 is a perspective view illustrating a liquid crystal display device.

FIGS. 8A and 8B are a top view of a pixel portion of a liquid crystal display device and a cross-sectional view thereof, respectively.

FIG. 9 is a cross-sectional view of a pixel portion of a liquid crystal display device.

FIG. 10 is a cross-sectional view of a pixel portion of a liquid crystal display device.

FIGS. 11A and 11B are a top view of a pixel portion of a liquid crystal display device and a cross-sectional view thereof, respectively.

FIGS. 12A to 12D each illustrate one mode of a transistor that can be applied to a liquid crystal display device.

FIGS. 13A to 13E illustrate one mode of a method for manufacturing a transistor that can be applied to a liquid crystal display device.

FIG. 14 is a top view illustrating an example of a pixel portion of a liquid crystal display device.

FIGS. 15A to 15D are cross-sectional views of a pixel portion of a liquid crystal display device.

FIG. 16 is a cross-sectional view of a pixel portion of a liquid crystal display device.

FIGS. 17A and 17B are an external view of a display device and a block diagram of a charge and discharge control circuit, respectively.

### BEST MODE FOR CARRYING OUT THE INVENTION

Hereinafter, embodiments of the present invention will be described in detail with reference to the accompanying drawings. However, the present invention is not limited to the description below, and it is easily understood by those skilled in the art that modes and details disclosed herein can be modified in various ways. Therefore, the present invention is not construed as being limited to description of the embodiments.

### Embodiment 1

In this embodiment, a liquid crystal display device having a still-image mode and a moving-image mode will be described with reference to drawings. Further, a means for determining the timing of rewriting operation to a pixel in a still-image mode will be described.

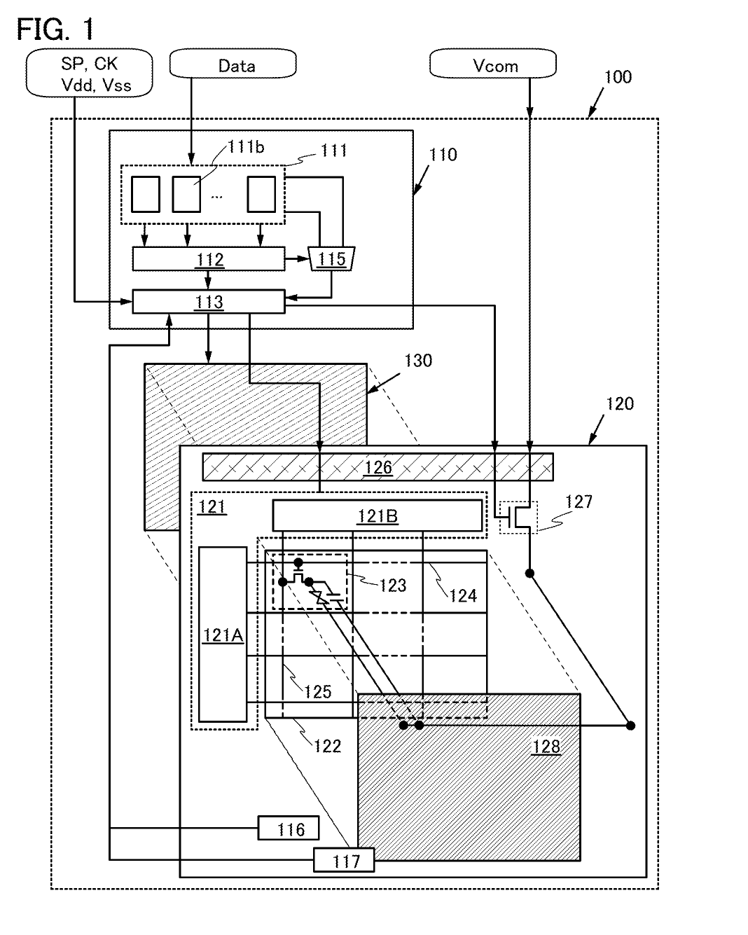

First, components of a display device 100 of this specification will be described with reference to a block diagram of a transmissive liquid crystal display device illustrated in FIG. 1. The display device 100 of this embodiment includes at least an image processing circuit 110, a display panel 120, and a backlight portion 130. Note that except for the backlight portion 130, a structure of a semi-transmissive liquid crystal display device may be employed.

The display device 100 of this embodiment is supplied with a control signal, an image signal, and a power source potential from external devices connected to the display device 100. A start pulse SP and a clock signal CK are supplied as control signals, an image signal Data is supplied as an image signal, and a high power source potential Vdd, a low power source potential Vss, and a common potential Vcom are supplied as power source potentials.

Note that the high power source potential Vdd is a potential higher than a reference potential, and the low power source potential Vss is a potential lower than or equal to the reference potential. It is desirable that each of the high power source potential Vdd and the low power source potential Vss be a potential at which a thin film transistor can operate. Note that the high power source potential Vdd and the low power source potential Vss are collectively referred to as a power source voltage in some cases.

The common potential Vcom may be any potential as long as it serves as a reference with respect to the potential of an image signal supplied to a pixel electrode. For example, the common potential may be a ground potential.

Note that the image signal Data may be appropriately inverted in accordance with dot inversion driving, source line inversion driving, gate line inversion driving, frame inversion driving, or the like to be input to the display panel 120. Note that in the case where the image signal is an analog signal, it may be converted into a digital signal through an A/D converter or the like to be supplied to the display device 100. With such a structure, a difference between the image signals can be easily detected.

Next, an image processing circuit and peripheral devices in one embodiment of the present invention will be described with reference to the drawing.

The image processing circuit 110 includes a memory circuit 111, a comparison circuit 112, and a display control circuit 113. The image processing circuit 110 generates a display panel signal and a backlight signal from the image signal Data which is input. The display panel signal is an image signal for controlling the display panel 120, and the backlight signal is a signal for controlling the backlight portion 130.

The memory circuit 111 includes a plurality of frame memories for storing image signals for a plurality of frames. The number of frame memories included in the memory circuit 111 is not particularly limited and the memory circuit 111 may be an element that can store the image signals for the plurality of frames. The frame memory may be formed using a memory element such as dynamic random access memory (DRAM) or static random access memory (SRAM).

The frame memory may employ any structure as long as an image signal is stored for each frame period. The image signals stored in the frame memories are selectively read by the comparison circuit 112 and the display control circuit 113. Note that frame memories 111b in the drawing each schematically show a memory region for one frame.

The comparison circuit 112 is a circuit which selectively reads out image signals in successive frames stored in the memory circuit 111, compares the image signals in each pixel, and detects a difference thereof.

A selection circuit 115 employs a structure in which a plurality of switches formed of transistors are provided, for example. The selection circuit 115 is a circuit which determines whether the image signal is a moving-image signal or a still-image signal from presence or absence of a difference between the image signals detected by the comparison circuit 112 and which selects whether or not the image signal is output from the frame memory in the memory circuit 111 to the display control circuit 113.

The display control circuit 113 is a circuit which supplies the display panel 120 with an image signal selected by the selection circuit 115 and a control signal (specifically, a signal for controlling the switching of supply and stop of a control signal such as the start pulse SP or the clock signal CK) and which supplies the backlight portion 130 with a backlight signal (specifically, which supplies a backlight control circuit with a signal for controlling lighting and extinction of the backlight).

Note that in the case where software provided for the liquid crystal display device of this embodiment determines whether an image source is for displaying a moving image or a still image, operation of the memory circuit 111, the comparison circuit 112, and the selection circuit 115 is not needed. Alternatively, a structure may be employed in which these circuits are not provided.

The backlight portion 130 includes the backlight control circuit and a light-emitting portion. A structure of the light-emitting portion may be selected depending on the intended use of the display device 100. For example, in the case where a full-color image is displayed, a light source including three primary colors of light is used for the light-emitting portion. In this embodiment, a white-light-emitting element (e.g., an LED) is used for the light-emitting portion, for example. Note that in this specification, the light-emitting portion used for the backlight portion 130 is also called simply a backlight.

Note that the back light control circuit of the backlight portion 130 is supplied with a backlight signal that controls the backlight and a power source potential from the display control circuit 113.

The display panel 120 includes a pixel portion 122 and a switching element 127. In this embodiment, the display panel 120 includes a first substrate and a second substrate, and a driver circuit portion 121, the pixel portion 122, and the switching element 127 are provided for the first substrate. A common connection portion (also referred to as a common contact) and a common electrode portion 128 (also referred to as a counter electrode portion) are provided for the second substrate. Note that the common connection portion electrically connects the first substrate and the second substrate, and may be provided over the first substrate.

In the pixel portion 122, a plurality of gate lines 124 and a plurality of signal lines 125 are provided, and a plurality of pixels 123 are provided in matrix so as to be surrounded by the gate lines 124 and the signal lines 125. Note that in the display panel 120 described in this embodiment, the gate lines 124 are extended from a gate line driver circuit 121A, and the signal lines 125 are extended from a signal line driver circuit 121B.

The pixels 123 each include a transistor, a pixel electrode connected to the transistor, a capacitor, and a display element. In this embodiment, a liquid crystal element is used as a display element.

An example of liquid crystal elements is an element which controls transmission and non-transmission of light by optical modulation action of liquid crystals. Such an element can be formed using a pair of electrodes and a liquid crystal layer. The optical modulation action of liquid crystals is controlled by an electric field (that is, a vertical electric field) applied to the liquid crystal.

Specifically, the following can be used for a liquid crystal element, for example: a nematic liquid crystal, a cholesteric liquid crystal, a smectic liquid crystal, a discotic liquid crystal, a thermotropic liquid crystal, a lyotropic liquid crystal, a low-molecular liquid crystal, a polymer dispersed liquid crystal, a ferroelectric liquid crystal, an anti-ferroelectric liquid crystal, a main-chain liquid crystal, a side-chain high-molecular liquid crystal, and a banana-shaped liquid crystal. Moreover, the following methods can be used for driving the liquid crystals, for example: a TN (twisted nematic) mode, an STN (super twisted nematic) mode, an IPS (in-plane-switching) mode, a VA (vertical alignment) mode, an OCB (optically compensated birefringence) mode, an ECB (electrically controlled birefringence) mode, an FLC (ferroelectric liquid crystal) mode, an AFLC (anti-ferroelectric liquid crystal) mode, a PDLC (polymer dispersed liquid crystal) mode, a PNLC (polymer network liquid crystal) mode, and a guest-host mode.

The driver circuit portion 121 includes the gate line driver circuit 121A and the signal line driver circuit 121B. The gate line driver circuit 121A and the signal line driver circuit 121B are each a driver circuit for driving the pixel portion 122 including a plurality of pixels, and include a shift register circuit (also referred to as a shift register).

Note that the gate line driver circuit 121A and the signal line driver circuit 121B may be formed over the same substrate as the pixel portion 122 or the switching element 127. Alternatively, the gate line driver circuit 121A and the signal line driver circuit 121B may be formed over another substrate.

The high power source potential Vdd, the low power source potential Vss, the start pulse SP, the clock signal CK, and the image signal Data which are controlled by the display control circuit 113 are supplied to the driver circuit portion 121.

A terminal portion 126 is an input terminal which supplies the driver circuit portion 121 with a predetermined signal (such as the high power source potential Vdd, the low power source potential Vss, the start pulse SP, the clock signal CK, the image signal Data, or the common potential Vcom) or the like output from the display control circuit 113 of the image processing circuit 110.

The switching element 127 supplies the common electrode portion 128 with the common potential Vcom in accordance with a control signal output from the display control circuit 113. As the switching element 127, a transistor can be used. The following structure may be employed: a gate electrode of the transistor is connected to the display control circuit 113, one of a source electrode and a drain electrode of the transistor is connected to the common potential Vcom through the terminal portion 126, and the other of the source electrode and the drain electrode of the transistor is connected to the common electrode portion 128. Note that the switching element 127 may be formed over the same substrate as the driver circuit portion 121 or the pixel portion 122. Alternatively, the switching element 127 may be formed over another substrate.

The common connection portion electrically connects the common electrode portion 128 and a terminal connected to the source electrode or the drain electrode of the switching element 127.

As a specific example of the common connection portion, conductive particles of metal or conductive particles in which an insulating sphere is coated with a thin metal film may be used, so that electrical connection is made. Note that two or more common connection portions may be provided between the first substrate and the second substrate.

The common electrode portion 128 overlaps with the plurality of pixel electrodes in the pixel portion 122. Further, the common electrode portion 128 and the pixel electrodes included in the pixel portion 122 may have a variety of opening patterns.

Next, a procedure in which the image processing circuit 110 processes a signal will be described.

In this embodiment, operation of the display control circuit 113 and operation of the selection circuit 115 are determined depending on a difference between the frames. In the case where the comparison circuit 112 detects a difference between the frames in any of the pixels, the comparison circuit 112 judges that the image signals are not for displaying a still image and that the image signals in the successive frame periods from which the difference is detected are for displaying a moving image.

On the other hand, in the case where a difference is not detected in all the pixels by comparing the image signals in the comparison circuit 112, the image signals in frame periods from which no difference is detected are judged as signals for displaying a still image.

Here, the moving image refers to an image which is recognized as a moving image with human eyes by rapid switch of a plurality of images which are time-divided into a plurality of frames. Specifically, by switching of images at least 60 times (60 frames) per second, the images are recognized as a smooth moving image with human eyes. In contrast, the still image refers to an image which is displayed with the use of image signals that are not changed in successive frames, for example, in the n-th frame and the (n+1)-th frame, although a plurality of images which are time-divided into a plurality of frame periods are rapidly switched to operate as in the case of the moving image.

In other words, depending on the presence or absence of a difference between image signals in successive frames, whether the image signals in successive frames are image signals for displaying a moving image or image signals for displaying a still image is determined by the comparison circuit 112. Note that the comparison circuit 112 may be set so as to judge detection of a difference from the absolute value of the difference.

In the case where the comparison circuit 112 does not detect a difference between the successive frames, that is, in the case where a still image is displayed, the selection circuit 115 stops output from the frame memories in the memory circuit 111 to the display control circuit 113. A structure in which an image signal is not output from the frame memories to the display control circuit 113 is employed, whereby power consumption of the display device can be reduced.

In this embodiment, the comparison circuit 112 detects a difference between image signals in successive frames, so that whether the image signal is a signal for displaying a still image or a moving image is judged; however, the display device may have a function of switching modes of displayed images. A function of switching modes of displayed images corresponds to a function of switching a moving-image mode and a still-image mode which is performed in such a manner that an operation mode of the display device is selected by users manually or with the use of an external connection terminal.

In the case where the display device has the above function, it is also possible for the selection circuit 115 to output an image signal to the display control circuit 113 in accordance with a signal input from a mode-switching circuit.

For example, it is assumed that a mode-switching signal is input from the mode-switching circuit to the selection circuit 115 when the still-image mode is employed. Then, even in the case where the comparison circuit 112 does not detect a difference between image signals in successive frame periods, the still-image mode can be changed to the moving-image mode in which image signals input from the memory circuit 111 to the selection circuit 115 are sequentially output to the display control circuit 113. In the case where a mode-switching signal is input from the mode-switching circuit to the selection circuit 115 when the moving-image mode is employed, the moving-image mode can be changed to the still-image mode by operation opposite to the above. As a result, in the display device of this embodiment, one frame in a moving image is displayed as a still image.

Note that as described above, in the case where software provided for the display device of this embodiment judges the mode of an image source (whether the image source is for displaying a moving image or a still image), the memory circuit 111, the comparison circuit 112, and the selection circuit 115 do not perform the above operation. In the case where the software judges the mode of an image source, a signal for controlling the mode of an image is directly input to the display control circuit 113 together with an image signal and thus display is controlled.

The display device may have an additional function of determining whether the mode of an image source is judged by the above circuits (hardware) or judged by the software and switching them as appropriate. Note that in a display device in which judgment of the mode of an image source is performed by only the software, the memory circuit 111, the comparison circuit 112, and the selection circuit 115 may be omitted.

In the display device described in this embodiment, an optical sensor 116 that can detect the brightness of an environment where the display device is set may be provided. The display control circuit 113 can change the driving method of the display panel 120 by illuminance detected by the optical sensor 116.

For example, when the optical sensor 116 detects weak external light, that is, when the optical sensor 116 detects that the display device is placed in a dark environment, the optical sensor 116 transmits a signal to the display control circuit 113 directly or through another circuit, and the display control circuit 113 controls the illuminance of the backlight in order to save electric power and improve recognition accuracy. In the case of a transmissive liquid crystal display device, brightness is preferably controlled to be low in a dark place because the recognition accuracy in a dark place is higher than that in a bright place. In the case of a semi-transmissive liquid crystal display device, the backlight which has been turned off is preferably turned on so that the recognition accuracy of display can be improved. In the case where darkness and brightness of an environment are changed inversely, the backlight is preferably controlled in a manner opposite to the above.

Next, operation of rewriting a signal to the pixel in the still-image mode (i.e., refresh operation) will be described.

In one embodiment of the present invention, the transistor whose off-state current is reduced is provided for the pixel 123 of the display device. When the transistor is in an off state, the display element connected to the transistor whose off-state current is reduced and charge accumulated in the capacitor are less likely to be leaked through the transistor in an off state. Therefore, a state in which a signal is written before the transistor is brought into an off state can be held for a long period of time.

However, the transistor does not serve as a completely nonvolatile transistor because off-state current flows even though the amount thereof might be extremely small; therefore, writing to the pixel should be repeatedly performed as needed in order to hold display. Off-state current of the transistor has temperature dependence, and is increased when the temperature is increased. In such a manner, when the off-state current of the transistor is changed due to an operation environment of the display device, a period during which the pixel can hold a predetermined potential is also changed; thus, an optimal interval of rewriting of a signal required for holding display (i.e., refresh operation) does not become constant.

In order to hold display in any environment, refresh operation is performed at regular time intervals; thus, the pixel can hold a potential. However, the intervals should be adapted to such an operation environment as is supposed to be the harshest, and electric power cannot be sufficiently saved when the intervals of refresh operation are made to be constant. In order to save electric power further, refresh operation is preferably performed as needed in accordance with the operation environment.

In order to realize that, a means which determines the timing of refresh operation by monitoring actual display states and detecting the change of the states may be employed. Specifically, an optical sensor 117 which detects illuminance of light delivered from the liquid crystal display panel side is used.

The optical sensor 117 is connected to the display control circuit 113 directly or through another circuit. When a rate of change in illuminance of light delivered from the liquid crystal display panel side reaches or exceeds a predetermined value, refresh operation of the pixel in the display region and a monitoring pixel which is to be described later is performed. Note that the optical sensor of this embodiment has at least a photoelectric conversion portion, and does not necessarily need to have a function of amplification, arithmetic, or the like. Amplification, arithmetic, or the like may be performed in another circuit.

As the optical sensor, a light-receiving element having sensitivity to visible light can be used. It preferably has peak sensitivity to light in the visible-light wavelength range. A light-receiving portion of the light-receiving element is disposed so as to transmit light from the liquid crystal display panel side.

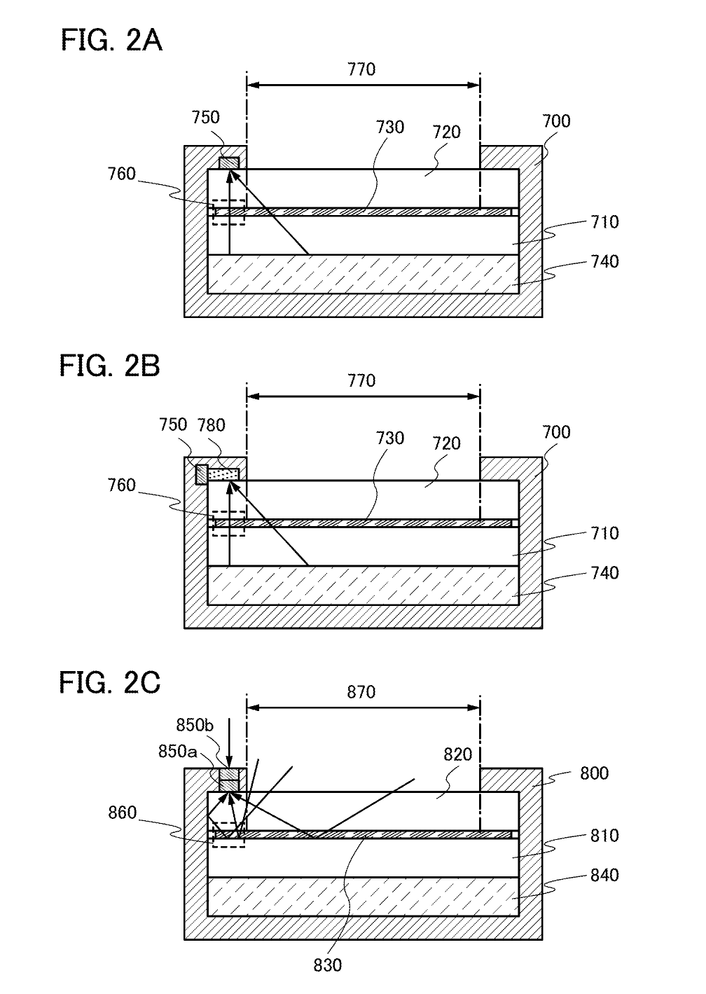

FIGS. 2A to 2C each schematically show a positional relationship between a liquid crystal display device and an optical sensor. Note that a transistor, a polarizing plate, and the like are not illustrated. FIG. 2A illustrates an example of a transmissive liquid crystal display device. A first substrate 710 over which a transistor is formed and a second substrate 720 on the opposite side of the first substrate 710 sandwich a liquid crystal layer 730, and a backlight portion 740 is provided on the first substrate 710 side. An optical sensor 750 is provided over the second substrate 720, and light from the backlight which is transmitted through the liquid crystal layer 730 enters the optical sensor through optical paths illustrated by arrows, for example. Here, the optical sensor 750 corresponds to the optical sensor 117 in FIG. 1.

At this time, light may enter the optical sensor 750 through a light guide plate 780. With the use of the light guide plate 780, the optical sensor 750 can be provided at a given position (see FIG. 2B). The number of the optical sensors is not limited to one, and a plurality of optical sensors may be provided. The positions and sizes of the optical sensors are not particularly limited as long as they are provided outside a display region of the liquid crystal display panel.

In a region 760 including the liquid crystal layer, which is indicated by a dotted line and is below the optical sensor 750, a monitoring pixel is formed in order to improve detection sensitivity of light. The optical sensor mainly detects light transmitted through the liquid crystal layer 730 of the monitoring pixel. This monitoring pixel is formed in a region that is covered with a housing 700 outside the display region, and the optical sensor 750 over the region is provided at a position to which light is not directly delivered from an opening portion 770 of the housing 700. Here, the number of the monitoring pixels is not limited to one, and a plurality of monitoring pixels may be provided in accordance with the positions and the number of the optical sensors. The sizes and the number of the monitoring pixels are optional, and may be determined by a practitioner in accordance with the sensitivity of the optical sensor or the design of the liquid crystal display panel.

The monitoring pixel is supplied with a potential so that display is performed, and change in transmitted light over time is monitored with the use of the optical sensor. For example, in the case of a normally-white liquid crystal device, there is a process in which black display is changed to white display due to a reduction in pixel potential, and refresh operation may be performed at the timing when a rate of change thereof reaches a predetermined value. In the case of a normally-black liquid crystal device, there is a process in which white display is changed to black display due to a reduction in pixel potential. Needless to say, these white display and black display do not have to be complete white display and black display as long as the change is detected at least in a halftone state. A color filter may be included in the monitoring pixel.

Whether a liquid crystal element employs a normally-white mode or a normally-black mode is determined by a relation between a liquid crystal and a polarizing plate. For example, in the case where polarizing plates arranged in a crossed Nicols state and a TN liquid crystal are used in combination, a normally-white mode is employed; in the case where polarizing plates arranged in a crossed Nicols state and an IPS liquid crystal or a VA liquid crystal are used in combination, a normally-black mode is employed.

FIG. 2C illustrates an example of a semi-transmissive liquid crystal display device, and a structure similar to the structure of the transmissive liquid crystal display device can be employed except for an optical sensor for detecting external light. A first substrate 810 over which a transistor is formed and a second substrate 820 on the opposite side of the first substrate 810 sandwich a liquid crystal layer 830, and a backlight portion 840 is provided on the first substrate 810 side. An optical sensor 850a is provided over the second substrate. Further, an optical sensor 850b for detecting external light is provided for refresh operation. Here, the optical sensor 850a corresponds to the optical sensor 117 in FIG. 1, and the optical sensor 850b for detecting external light may also serve as the optical sensor 116.

A monitoring pixel is formed in a region 860, and is completely covered with a housing 800 including an opening portion 870. Even in the case where the semi-transmissive liquid crystal display device is used as a reflective type, the monitoring pixel has an effect of improving detection sensitivity of light on the optical sensor. Here, the number of the optical sensors, the number of the optical sensors for detecting external light, and the number of the monitoring pixels are each not limited to one, and they each may be provided in plurality.

In the case where the backlight operates and the semi-transmissive liquid crystal display device is used as a transmissive type, the operation of the semi-transmissive liquid crystal display device is the same as that of the transmissive liquid crystal display device. On the other hand, in the case where the semi-transmissive liquid crystal display device is used as a reflective type, light which is transmitted through the liquid crystal layer 830 and is reflected enters the optical sensor 850a through optical paths illustrated by arrows in the drawing, for example. Illuminance of each reflected light depends on illuminance of external light.

That is, change in illuminance of reflected light from the liquid crystal display panel side which is detected by the optical sensor 850a over time is due to change in external light as well as a reduction in potential of the pixel. Therefore, a rate of change in illuminance of reflected light due to a reduction in potential of the pixel is calculated from a difference between a rate of change in illuminance of external light detected by the optical sensor 850b for detecting external light and a rate of change in illuminance of reflected light detected by the optical sensor 850a. Thus, the timing of refresh operation can be determined.

This refresh operation may be performed at the timing before a viewer can easily perceive deterioration in image quality. Note that in the liquid crystal display device of this embodiment, the period of time of holding a pixel potential is extremely long and image quality does not rapidly deteriorate. Therefore, even when image quality deteriorates actually, a viewer cannot perceive that in some cases because the image quality deteriorates gradually. Thus, if refresh operation is performed so as to rapidly recover the image quality, a viewer perceives that and feels an unnatural display state. In order to prevent this, refresh operation may be performed so as to increase the pixel potential gradually; thus, the image quality may be recovered gradually such that a viewer cannot easily perceive a change in image quality.

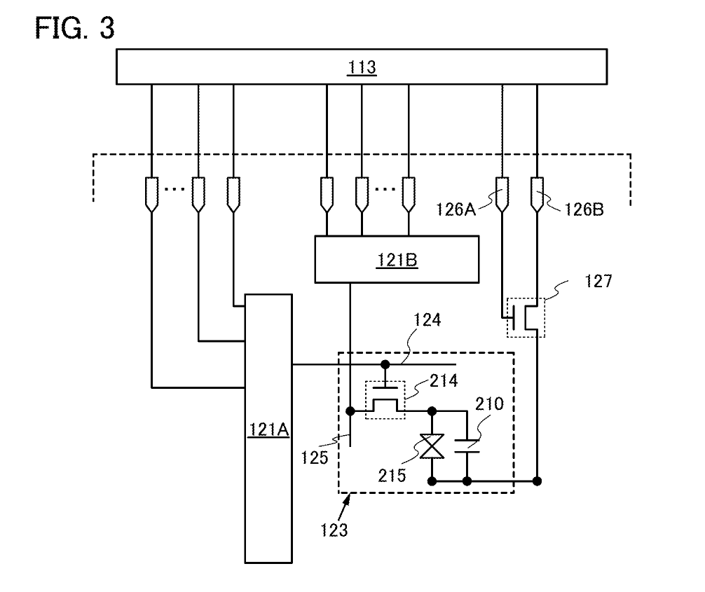

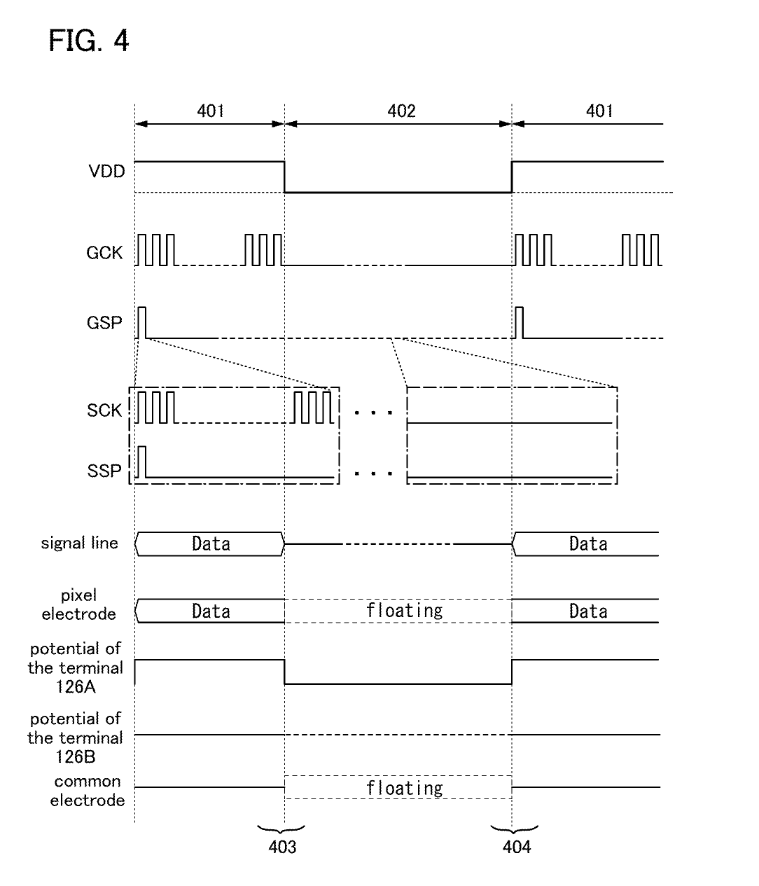

Next, a signal supplied to the pixel will be described with reference to an equivalent circuit diagram of a display device in FIG. 3 and a timing chart in FIG. 4.

As shown in FIG. 3, the pixel 123 is provided with a transistor 214, a display element 215, and a capacitor 210. Note that a liquid crystal element is used as the display element 215 in this embodiment.

A gate electrode of the transistor 214 is connected to one of the plurality of gate lines 124 provided in the pixel portion. One of a source electrode and a drain electrode of the transistor 214 is connected to one of the plurality of signal lines 125. The other of the source electrode and the drain electrode of the transistor 214 is connected to one electrode of the capacitor 210 and one electrode of the display element 215.

With such a structure, the capacitor 210 can hold a voltage applied to the display element 215. Note that a structure may be employed in which the capacitor 210 is not provided. The other electrode of the capacitor 210 may be connected to a capacitor line which is not illustrated here.

One of the source electrode and the drain electrode of the switching element 127 is connected to the other electrode of the capacitor 210 and one electrode of the display element 215. The other of the source electrode and the drain electrode of the switching element 127 is connected to a terminal 126B through a common connection portion. A gate electrode of the switching element 127 is connected to a terminal 126A.

In the timing chart of FIG. 4, a clock signal GCK and a start pulse GSP with which the gate line driver circuit 121A is supplied by the display control circuit 113 are illustrated. In addition, a clock signal SCK and a start pulse SSP with which the signal line driver circuit 121B is supplied by the display control circuit 113 are illustrated. Note that, for the description of the timing at which the clock signal is output, the wavelength of the clock signal is shown by a simple rectangular wave in FIG. 4.

In FIG. 4, a potential of the signal line 125, a potential of the pixel electrode, a potential of the terminal 126A, a potential of the terminal 126B, and a potential of the common electrode portion are illustrated.

A period 401 in FIG. 4 corresponds to a period during which image signals for displaying a moving image are written. In the period 401, operation is performed so that the image signals and the common potential are supplied to the pixels in a pixel circuit portion and the common electrode portion.

Further, a period 402 corresponds to a period during which a still image is displayed. In the period 402, the supply of the image signals and the common potential to the pixels in the pixel circuit portion and the common electrode is stopped. Note that each signal is supplied in the period 402 in FIG. 4 so that operation of the driver circuit portion is stopped; however, it is preferable to prevent deterioration of an image by refresh operation as needed in order to hold a still image. In this embodiment, a method for determining the timing with the use of an optical sensor is described.

In the period 401, a clock signal is supplied at all times as the clock signal GCK, and a pulse is supplied as the start pulse GSP in accordance with a vertical synchronization frequency. Further, in the period 401, a clock signal is supplied at all times as the clock signal SCK, and a pulse is supplied as the start pulse SSP in accordance with one gate selection period.

Further, in the period 401, the image signal Data is supplied to the pixel of each row through the signal line 125, and the potential of the signal line 125 is supplied to the pixel electrode in accordance with the potential of the gate line 124.

Moreover, in the period 401, the display control circuit supplies the terminal 126A connected to the gate electrode of the switching element 127 with a potential at which the switching element 127 is turned on, and supplies the common electrode portion with the common potential through the terminal 126B.

On the other hand, in the period 402, the supply of the clock signal GCK, the start pulse GSP, the clock signal SCK, and the start pulse SSP is stopped. Further, in the period 402, the supply of the image signal Data which has been supplied to the signal line 125 is also stopped. In the period 402 during which the supply of both the clock signal GCK and the start pulse GSP is stopped, the transistor 214 in the pixel is turned off; thus, the pixel electrode is brought into a floating state.

In the period 402, the display control circuit supplies the terminal 126A connected to the gate electrode of the switching element 127 with a potential at which the switching element 127 is turned off, and the common electrode portion is brought into a floating state.

In the period 402, the pixel electrode of the display element 215 and the common electrode portion are brought into a floating state; thus, a still image can be displayed without the supply of another potential in the period 402.

The supply of a clock signal and a start pulse to the gate line driver circuit 121A and the signal line driver circuit 121B is stopped, whereby low power consumption can be achieved.

In particular, with the use of a transistor whose off-state current is reduced for the transistor 214 of the pixel and the switching element 127, a voltage which is applied to both the terminals of the display element 215 can be prevented from being lowered over time.

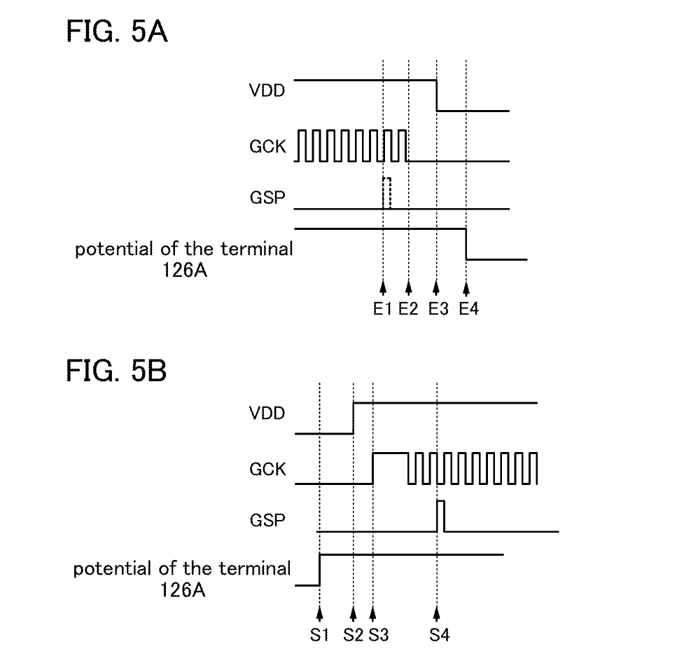

Next, operation of the display control circuit in a period during which a moving image is changed to a still image (a period 403 in FIG. 4) and a period during which a still image is changed to a moving image (a period 404 in FIG. 4) will be described with reference to FIGS. 5A and 5B. FIGS. 5A and 5B are each a timing chart of the high power source potential Vdd, the clock signal (here, GCK), the start pulse signal (here, GSP), and the potential of the terminal 126A which are output from the display control circuit.

Operation of the display control circuit in the period during which a moving image is changed to a still image is shown in FIG. 5A. The display control circuit stops the supply of the start pulse GSP (E1 in FIG. 5A). Next, the supply of the start pulse GSP is stopped and then, supply of a plurality of clock signals GCK is stopped after pulse output reaches the last stage of the shift register (E2 in FIG. 5A). Then, the high power source potential Vdd of a power source voltage is changed to the low power source potential Vss (E3 in FIG. 5A). After that, the potential of the terminal 126A is changed to a potential at which the switching element 127 is turned off (E4 in FIG. 5A).

Through the above steps, the supply of signals to the driver circuit portion 121 can be stopped without malfunction of the driver circuit portion 121. Malfunction in changing a moving image to a still image causes noise, and a still image affected by the noise is held. Therefore, a display device mounted with a display control circuit in which malfunction is less likely to be caused can display a still image whose quality is scarcely deteriorated.

Next, operation of the display control circuit in the period during which a still image is changed to a moving image is shown in FIG. 5B. The display control circuit changes the potential of the terminal 126A to a potential at which the switching element 127 is turned on (S1 in FIG. 5B). Then, a power source voltage is changed from the low power source potential Vss to the high power source potential Vdd (S2 in FIG. 5B). Next, a high-level potential is applied before the supply of the clock signal, and then the plurality of clock signals GCK are supplied (S3 in FIG. 5B). Next, the start pulse signal GSP is supplied (S4 in FIG. 5B).

Through the above steps, the supply of drive signals to the driver circuit portion 121 can be restarted without malfunction of the driver circuit. The potentials of the wirings are sequentially changed back to those at the time of displaying a moving image, so that the driver circuit portion can be driven without malfunction.

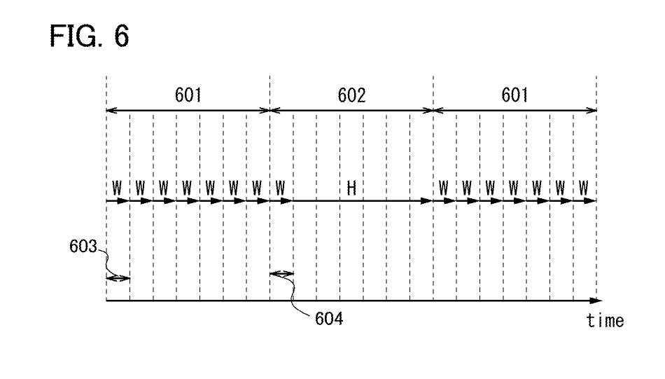

FIG. 6 schematically shows the frequency of writing of an image signal per frame period, in a period 601 during which a moving image is displayed and in a period 602 during which a still image is displayed. In FIG. 6, “W” indicates a period during which an image signal is written, and “H” indicates a period during which the image signal is held. In addition, a period 603 is one frame period in FIG. 6; however, the period 603 may be a different period.

Thus, in the structure of the display device of this embodiment, an image signal for a still image displayed in the period 602 is written in a period 604, and the image signal written in the period 604 is held in the period 602.

Through the above steps, in the display device described in this embodiment, the moving-image mode and the still-image mode can be automatically switched to each other, and the frequency of writing of an image signal can be reduced in the period during which a still image is displayed. As a result, power consumption at the time of displaying a still image can be reduced.

When a still image is displayed, the timing of refresh operation is determined not by setting the time but by monitoring an actual display state with the use of an optical sensor. Further, refresh operation is performed at intervals suitable for the operation environment, whereby power consumption can be further reduced.

This embodiment can be implemented in appropriate combination with any of the structures described in the other embodiments.

### Embodiment 2

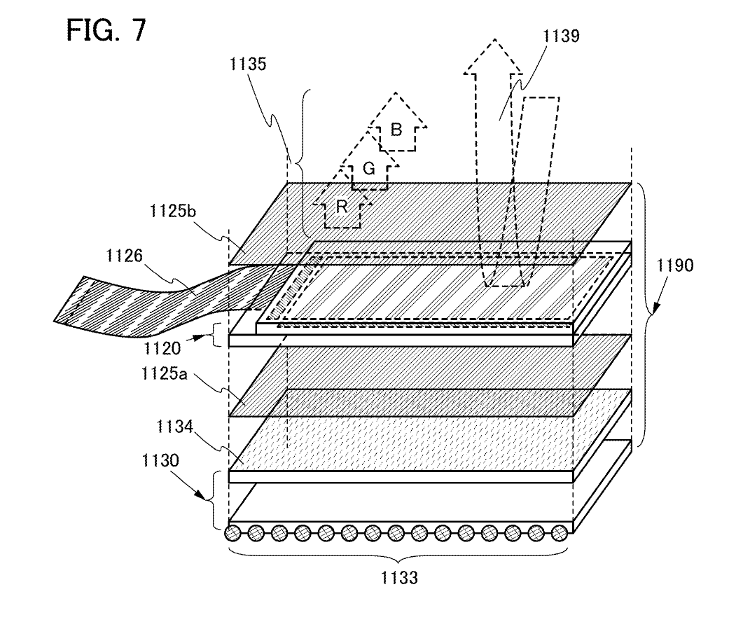

In FIG. 7, a structure of a liquid crystal display module 1190 is shown. The liquid crystal display module 1190 includes a backlight portion 1130; a color filter provided at a position overlapping with the backlight portion 1130; a display panel 1120 in which liquid crystal elements are arranged in matrix; and a polarizing plate 1125a and a polarizing plate 1125b which are provided with the display panel 1120 positioned therebetween. The backlight portion 1130 is a surface-emitting backlight portion which emits uniform white light. For example, the backlight portion 1130 may include a white LED 1133 placed in an end portion of a light guide plate and a diffusing plate 1134 provided between the light guide plate and the display panel 1120. In addition, a flexible printed circuit (FPC) 1126 serving as an external input terminal is electrically connected to a terminal portion provided in the display panel 1120.

In FIG. 7, light 1135 of three colors is schematically denoted by arrows (R, G, and B). Light emitted from the backlight portion 1130 is modulated by a liquid crystal element overlapping with the color filter of the display panel 1120 and reaches a viewer through the liquid crystal display module 1190, so that the viewer perceives an image.

Further, FIG. 7 schematically illustrates a state in which external light 1139 is transmitted through the liquid crystal element over the display panel 1120 and reflected by an electrode below the liquid crystal element. The intensity of the light transmitted through the liquid crystal element is modulated by an image signal; therefore, a viewer can perceive an image also by reflection light of the external light 1139.

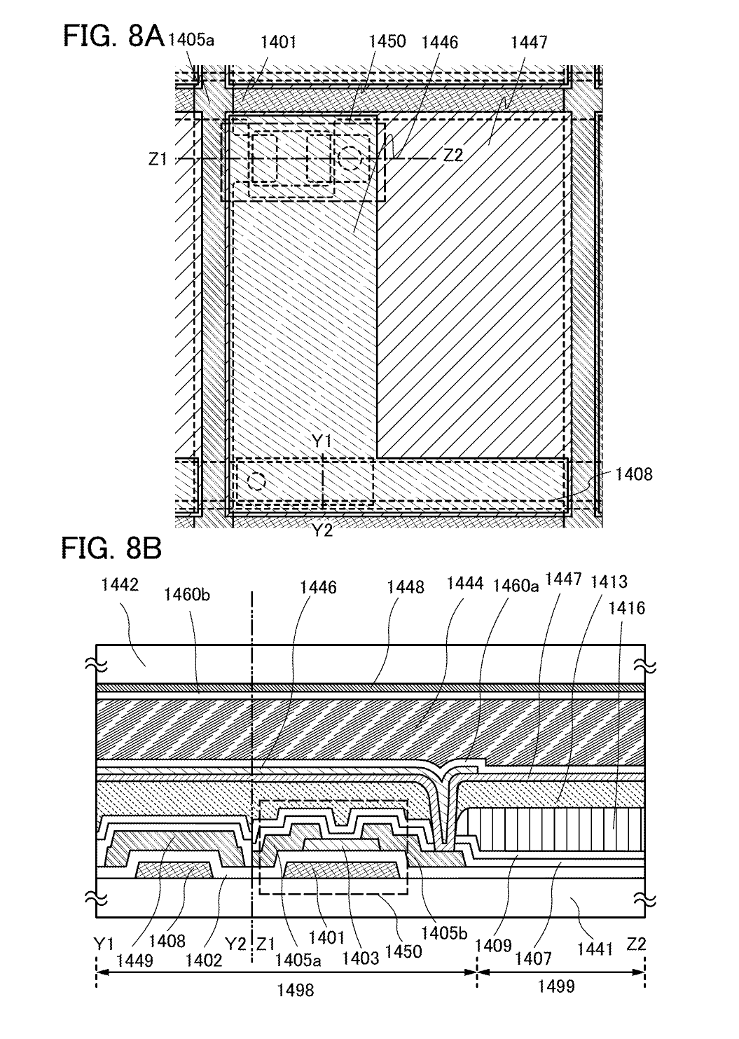

FIG. 8A is a plan view of a display region and illustrates one pixel thereof. FIG. 8B is a cross-sectional view taken along lines Y1-Y2 and Z1-Z2 of FIG. 8A.

In FIG. 8A, a plurality of source wiring layers (including a source or drain electrode layer 1405a) are arranged in parallel (extend in the vertical direction in the drawing) to be spaced from each other. A plurality of gate wiring layers (including a gate electrode layer 1401) is provided to extend in a direction generally perpendicular to the source wiring layers (the horizontal direction in the drawing) and to be spaced from each other. Capacitor wiring layers 1408 are arranged adjacent to the plurality of gate wiring layers and extend in a direction generally parallel to the gate wiring layers, that is, in a direction generally perpendicular to the source wiring layers (in the horizontal direction in the drawing).

The liquid crystal display device in FIGS. 8A and 8B is a semi-transmissive liquid crystal display device in which a pixel region includes a reflective region 1498 and a transmissive region 1499. In the reflective region 1498, a reflective electrode layer 1446 is stacked as a pixel electrode layer over a light-transmitting conductive layer 1447, and in the transmissive region 1499, only the light-transmitting conductive layer 1447 is provided as a pixel electrode layer. Note that an example in which the light-transmitting conductive layer 1447 and the reflective electrode layer 1446 are stacked in this order over an interlayer film 1413 is illustrated in FIGS. 8A and 8B; however, a structure in which the reflective electrode layer 1446 and the light-transmitting conductive layer 1447 are stacked in this order over the interlayer film 1413 may be employed. An insulating film 1407, an insulating film 1409, and the interlayer film 1413 are provided over a transistor 1450. The light-transmitting conductive layer 1447 and the reflective electrode layer 1446 are electrically connected to the transistor 1450 through an opening (a contact hole) provided in the insulating film 1407, the insulating film 1409, and the interlayer film 1413. In the transmissive region 1499, a coloring layer 1416 functioning as a color filter layer is provided between the insulating film 1409 and the interlayer film 1413.

As illustrated in FIG. 8B, a common electrode layer 1448 (also referred to as a counter electrode layer) is formed on a second substrate 1442 and faces the light-transmitting conductive layer 1447 and the reflective electrode layer 1446 over a first substrate 1441 with a liquid crystal layer 1444 provided therebetween. Note that in the liquid crystal display device in FIGS. 8A and 8B, an alignment film 1460a is provided between the light-transmitting conductive layer 1447 and the reflective electrode layer 1446, and the liquid crystal layer 1444. An alignment film 1460b is provided between the common electrode layer 1448 and the liquid crystal layer 1444. The alignment films 1460a and 1460b are insulating layers having a function of controlling the alignment of liquid crystal and therefore, are not necessarily provided depending on a material of the liquid crystal.

The transistor 1450 is an example of an inverted staggered transistor having a bottom-gate structure and includes the gate electrode layer 1401, a gate insulating layer 1402, a semiconductor layer 1403, the source or drain electrode layer 1405a, and a source or drain electrode layer 1405b. In addition, the capacitor wiring layer 1408 which is formed in the same step as the gate electrode layer 1401, the gate insulating layer 1402, and a conductive layer 1449 which is formed in the same step as the source or drain electrode layer 1405a and the source or drain electrode layer 1405b are stacked to form a capacitor. Note that the reflective electrode layer 1446 which is formed using a reflective conductive film of aluminum (Al), silver (Ag), or the like is preferably provided so as to cover the capacitor wiring layer 1408.

The semi-transmissive liquid crystal display device in this embodiment performs color display of moving images in the transmissive region 1499 and monochrome (black and white) display of still images in the reflective region 1498 by control of turning on and off the transistor 1450.

In the transmissive region 1499, image display is performed by incident light from a backlight provided on the first substrate 1441 side. When the coloring layer 1416 functioning as a color filter is provided in the liquid crystal display device, light from the back light is transmitted through the coloring layer 1416, whereby color display can be performed in the transmissive region. For example, in the case of performing full-color display, the color filter may be formed using a material showing red (R), green (G), or blue (B), or may be formed using another material showing yellow, cyan, magenta, or the like.

In FIGS. 8A and 8B, the coloring layer 1416 functioning as a color filter is provided between the protective insulating film 1409 and the interlayer film 1413. Since the coloring layer 1416 functions as a color filter, a light-transmitting resin layer which is formed using a material transmitting only light colored with chromatic color may be used. An optimal thickness of the coloring layer 1416 may be adjusted as appropriate in consideration of relation between the concentration of a coloring material included and the transmittivity of light. In the case where the thickness of the light-transmitting chromatic color resin layer varies depending on the chromatic colors or in the case where there is surface unevenness due to a transistor, an insulating layer which transmits light in a visible wavelength range (a so-called colorless, transparent insulating layer) may be stacked for planarization of the surface of the interlayer film.

In the case where the coloring layer 1416 is directly formed on the first substrate 1441 side, the formation region can be controlled more precisely and this structure is adjustable to a pixel with a minute pattern. Alternatively, the coloring layer 1416 can be used as an interlayer film.

The coloring layer 1416 may be formed using a photosensitive or a non-photosensitive organic resin by a coating method.

On the other hand, in the reflective region 1498, image display is performed by reflecting external light incident from the second substrate 1442 side by the reflective electrode layer 1446.

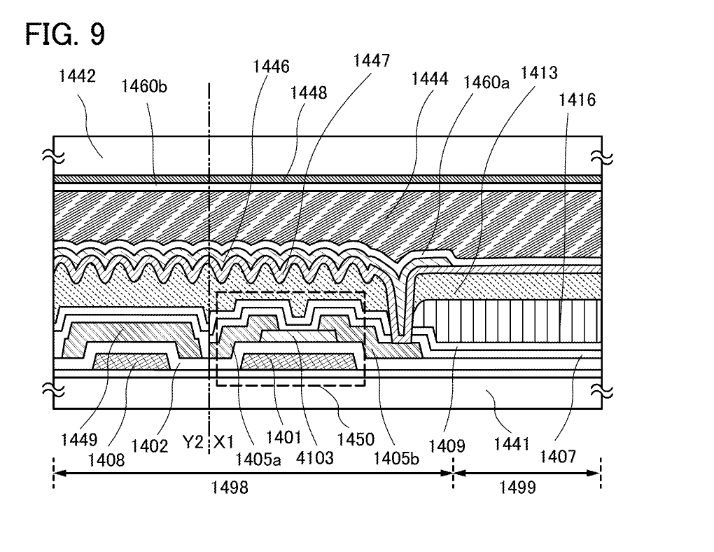

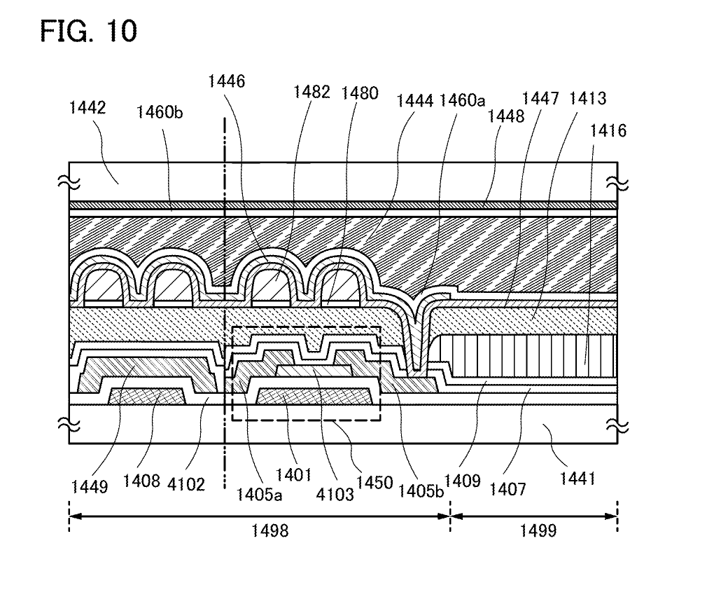

Examples in which the reflective electrode layer 1446 is formed to have unevenness in the liquid crystal display device are illustrated in FIG. 9 and FIG. 10. FIG. 9 illustrates an example in which a surface of the interlayer film 1413 in the reflective region 1498 is formed to have an uneven shape so that the reflective electrode layer 1446 has an uneven shape. The uneven shape of the surface of the interlayer film 1413 may be formed by performing selective etching. For example, the interlayer film 1413 having the uneven shape can be formed by performing a photolithography step on a photosensitive organic resin. FIG. 10 illustrates an example in which projected structure bodies are provided over the interlayer film 1413 in the reflective region 1498 so that the reflective electrode layer 1446 has an uneven shape. Note that in FIG. 10, the projected structure bodies are formed by stacking an insulating layer 1480 and an insulating layer 1482. For example, an inorganic insulating layer of silicon oxide, silicon nitride, or the like can be used as the insulating layer 1480, and an organic resin such as a polyimide resin or an acrylic resin can be used as the insulating layer 1482. First, a silicon oxide film is formed over the interlayer film 1413 by a sputtering method, and a polyimide resin film is formed over the silicon oxide film by a coating method. The polyimide resin film is etched with the use of the silicon oxide film as an etching stopper. The silicon oxide film is etched with the use of the etched polyimide resin layer as a mask, so that the projected structure bodies including a stack of the insulating layer 1480 and the insulating layer 1482 can be formed as illustrated in FIG. 10.

When the reflective electrode layer 1446 has an uneven surface as illustrated in FIG. 9 and FIG. 10, incident light from the outside is irregularly reflected, so that more favorable image display can be performed. Accordingly, the visibility of image display is improved.

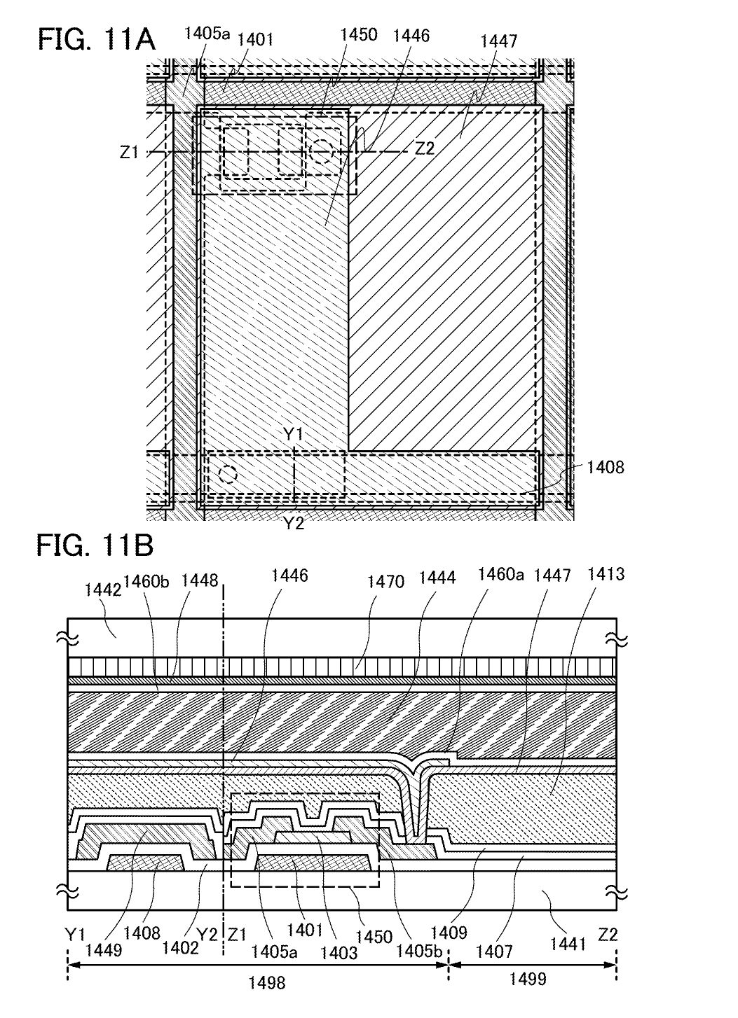

Note that FIGS. 8A and 8B, FIG. 9, and FIG. 10 each illustrate an example in which monochrome display is performed in the reflective region 1498; however, color display can also be performed in the reflective region 1498. FIGS. 11A and 11B illustrate an example in which full-color display is performed in both the transmissive region 1499 and the reflective region 1498.

FIGS. 11A and 11B illustrate an example in which a color filter 1470 is provided between the second substrate 1442 and the common electrode layer 1448. By providing the color filter 1470 between the reflective electrode layer 1446 and the second substrate 1442 on a viewer side, light reflected by the reflective electrode layer 1446 is transmitted through the color filter 1470, so that color display can be performed.

The color filter may be provided on an outer side of the second substrate 1442 (on a side opposite to the liquid crystal layer 1444).

Note that also in FIG. 9 and FIG. 10, if the color filter 1470 is provided as illustrated in FIG. 11B instead of the coloring layer 1416, full-color display can also be performed in the reflective region 1498.

This embodiment can be implemented in appropriate combination with any of the structures described in the other embodiments.

### Embodiment 3

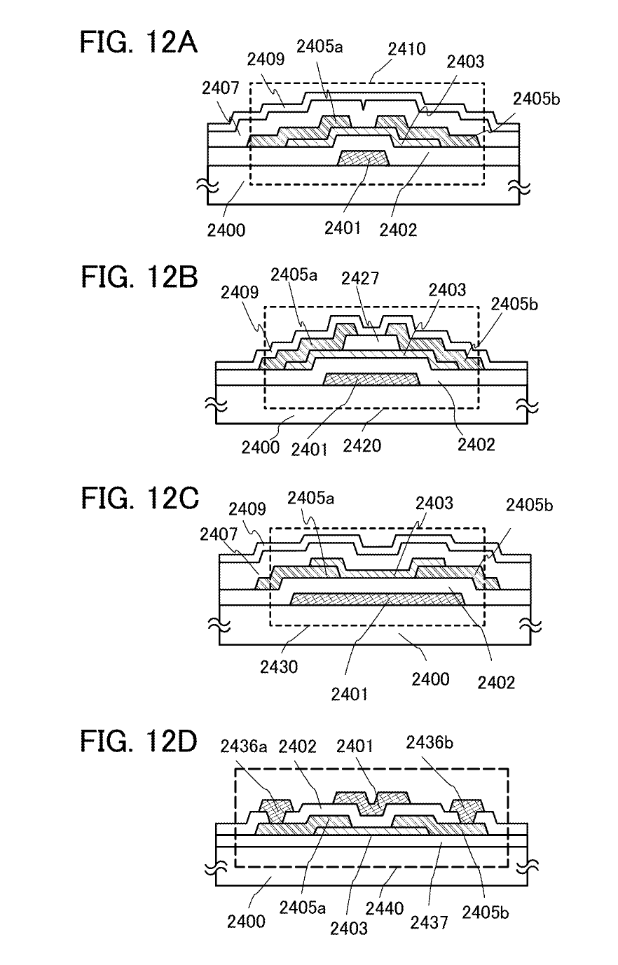

In this embodiment, another example of a transistor that can be applied to a liquid crystal display device disclosed in this specification will be described. There is no particular limitation on the structure of the transistor that can be applied to a liquid crystal display device disclosed in this specification; for example, a staggered type or a planar type having a top-gate structure or a bottom-gate planar structure can be employed. The transistor may have a single-gate structure in which one channel formation region is formed, a double-gate structure in which two channel formation regions are formed, or a triple-gate structure in which three channel formation regions are formed. Alternatively, the transistor may have a dual-gate structure including two gate electrode layers positioned over and below a channel formation region with a gate insulating layer provided therebetween. FIGS. 12A to 12D each illustrate an example of a cross-sectional structure of a transistor. Transistors illustrated in FIGS. 12A to 12D each include an oxide semiconductor. An advantage of using an oxide semiconductor is that high mobility and low off-state current can be obtained in a relatively easy and low-temperature process: however, it is needless to say that another semiconductor may be used.

A transistor 2410 illustrated in FIG. 12A is one of bottom-gate thin film transistors and is also called an inverted staggered thin film transistor.

The transistor 2410 includes, over a substrate 2400 having an insulating surface, a gate electrode layer 2401, a gate insulating layer 2402, an oxide semiconductor layer 2403, a source electrode layer 2405a, and a drain electrode layer 2405b. In addition, an insulating layer 2407 which covers the transistor 2410 and is stacked over the oxide semiconductor layer 2403 is provided. A protective insulating layer 2409 is formed over the insulating layer 2407.

A transistor 2420 illustrated in FIG. 12B is one of bottom-gate structures called a channel protective structure and is also referred to as an inverted staggered thin film transistor.

The transistor 2420 includes, over the substrate 2400 having an insulating surface, the gate electrode layer 2401, the gate insulating layer 2402, the oxide semiconductor layer 2403, an insulating layer 2427 functioning as a channel protective layer which covers a channel formation region of the oxide semiconductor layer 2403, the source electrode layer 2405a, and the drain electrode layer 2405b. The protective insulating layer 2409 is formed so as to cover the transistor 2420.

A transistor 2430 illustrated in FIG. 12C is a bottom-gate thin film transistor, and includes, over the substrate 2400 having an insulating surface, the gate electrode layer 2401, the gate insulating layer 2402, the source electrode layer 2405a, the drain electrode layer 2405b, and the oxide semiconductor layer 2403. The insulating layer 2407 which covers the transistor 2430 and is in contact with the oxide semiconductor layer 2403 is provided. The protective insulating layer 2409 is formed over the insulating layer 2407.

In the transistor 2430, the gate insulating layer 2402 is provided on and in contact with the substrate 2400 and the gate electrode layer 2401, and the source electrode layer 2405a and the drain electrode layer 2405b are provided on and in contact with the gate insulating layer 2402. Further, the oxide semiconductor layer 2403 is provided over the gate insulating layer 2402, the source electrode layer 2405a, and the drain electrode layer 2405b.

A transistor 2440 illustrated in FIG. 12D is one of top-gate thin film transistors. The transistor 2440 includes, over the substrate 2400 having an insulating surface, an insulating layer 2437, the oxide semiconductor layer 2403, the source electrode layer 2405a, the drain electrode layer 2405b, the gate insulating layer 2402, and the gate electrode layer 2401. A wiring layer 2436a and a wiring layer 2436b are provided to be in contact with and electrically connected to the source electrode layer 2405a and the drain electrode layer 2405b, respectively.

In this embodiment, the oxide semiconductor layer 2403 is used as a semiconductor layer included in a transistor as described above. As an oxide semiconductor material used for the oxide semiconductor layer 2403, any of the following metal oxides can be used: an In—Sn—Ga—Zn—O-based metal oxide which is a four-component metal oxide; an In—Ga—Zn—O-based metal oxide, an In—Sn—Zn—O-based metal oxide, an In—Al—Zn—O-based metal oxide, a Sn—Ga—Zn—O-based metal oxide, an Al—Ga—Zn—O-based metal oxide, and a Sn—Al—Zn—O-based metal oxide which are three-component metal oxides; an In—Zn—O-based metal oxide, a Sn—Zn—O-based metal oxide, an Al—Zn—O-based metal oxide, a Zn—Mg—O-based metal oxide, a Sn—Mg—O-based metal oxide, and an In—Mg—O-based metal oxide which are two-component metal oxides; an In—O-based metal oxide; a Sn—O-based metal oxide; and a Zn—O-based metal oxide. Further, Si may be contained in the oxide semiconductor. Here, for example, an In—Ga—Zn—O-based oxide semiconductor is an oxide containing at least In, Ga, and Zn, and there is no particular limitation on the composition ratio thereof. Further, the In—Ga—Zn—O-based oxide semiconductor may contain an element other than In, Ga, and Zn.

For the oxide semiconductor layer 2403, a thin film represented by the chemical formula, InMO₃(ZnO)ₘ (m>0) can be used. Here, M represents one or more metal elements selected from Ga, Al, Mn, and Co. For example, M can be Ga, Ga and Al, Ga and Mn, Ga and Co, or the like.

In the transistors 2410, 2420, 2430, and 2440 each including the oxide semiconductor layer 2403, the current value in an off state (off-state current value) can be small. Therefore, the holding period of an electric signal of image data or the like can be extended and an interval between writing operations can be set longer. Thus, the frequency of refresh operation can be reduced, which leads to an effect of suppressing power consumption.

In addition, each of the transistors 2410, 2420, 2430, and 2440 which include the oxide semiconductor layer 2403 can operate at high speed because they can achieve field-effect mobility that is relatively higher. Therefore, with the use of the transistor for a pixel portion of a liquid crystal display device, a high-quality image can be provided. In addition, because over one substrate, a driver circuit portion and a pixel portion can be formed with the use of the transistor, the number of components of the liquid crystal display device can be reduced.

As the substrate 2400 having an insulating surface, a glass substrate formed of barium borosilicate glass, aluminoborosilicate glass, or the like can be used.

In the bottom-gate transistors 2410, 2420, and 2430, an insulating film serving as a base film may be provided between the substrate and the gate electrode layer. The base film has a function of preventing diffusion of an impurity element from the substrate, and can be formed to have a single-layer structure or a stacked-layer structure using one or more films selected from a silicon nitride film, a silicon oxide film, a silicon nitride oxide film, and a silicon oxynitride film.

The gate electrode layer 2401 can be formed to have a single-layer structure or a stacked-layer structure using a metal material such as molybdenum, titanium, chromium, tantalum, tungsten, aluminum, copper, neodymium, or scandium, or an alloy material which contains any of these materials as its main component.

The gate insulating layer 2402 can be formed to have a single-layer structure or a stacked-layer structure using a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, or a hafnium oxide layer, by a plasma CVD method, a sputtering method, or the like. For example, by a plasma CVD method, a silicon nitride layer (SiN_{y} (y>0)) with a thickness of greater than or equal to 50 nm and less than or equal to 200 nm is formed as a first gate insulating layer, and a silicon oxide layer (SiOₓ (x>0)) with a thickness of greater than or equal to 5 nm and less than or equal to 300 nm is formed as a second gate insulating layer over the first gate insulating layer, so that a gate insulating layer with a total thickness of 200 nm is formed.

As the conductive film used for the source electrode layer 2405a and the drain electrode layer 2405b, for example, a film including an element selected from Al, Cr, Cu, Ta, Ti, Mo, or W, a film including an alloy containing any of these elements, or the like can be used. Alternatively, a structure may be employed in which a high-melting-point metal layer of Ti, Mo, W, or the like is stacked over and/or below a metal layer of Al, Cu, or the like. When an Al material to which an element (Si, Nd, Sc, or the like) preventing generation of a hillock or a whisker in an Al film is added is used, heat resistance can be increased.

A material similar to that of the source electrode layer 2405a and the drain electrode layer 2405b can be used for a conductive film such as the wiring layer 2436a and the wiring layer 2436b which are connected to the source electrode layer 2405a and the drain electrode layer 2405b, respectively.

Alternatively, the conductive film to be the source electrode layer 2405a and the drain electrode layer 2405b (including a wiring layer formed using the same layer as the source and drain electrode layers) may be formed using a conductive metal oxide. Examples of the conductive metal oxide are indium oxide (In₂O₃), tin oxide (SnO₂), zinc oxide (ZnO), an alloy of indium oxide and tin oxide (In₂O₃—SnO₂, abbreviated to ITO), an alloy of indium oxide and zinc oxide (In₂O₃—ZnO), and such a metal oxide material containing silicon.

As the insulating layers 2407, 2427, and 2437, an inorganic insulating film typical examples of which are a silicon oxide film, a silicon oxynitride film, an aluminum oxide film, and an aluminum oxynitride film can be used.

As the protective insulating layer 2409, an inorganic insulating film such as a silicon nitride film, an aluminum nitride film, a silicon nitride oxide film, or an aluminum nitride oxide film can be used.

A planarization insulating film may be formed over the protective insulating layer 2409 in order to reduce surface unevenness caused by the structure of the transistor. As the planarization insulating film, an organic material such as polyimide, acrylic, or benzocyclobutene can be used. As an alternative to such organic materials, it is possible to use a low-dielectric constant material (a low-k material) or the like. Note that the planarization insulating film may be formed by stacking a plurality of insulating films formed using these materials.

As described above, in this embodiment, a high-performance liquid crystal display device can be provided by using a transistor including an oxide semiconductor layer.

This embodiment can be implemented in appropriate combination with any of the structures described in the other embodiments.

### Embodiment 4

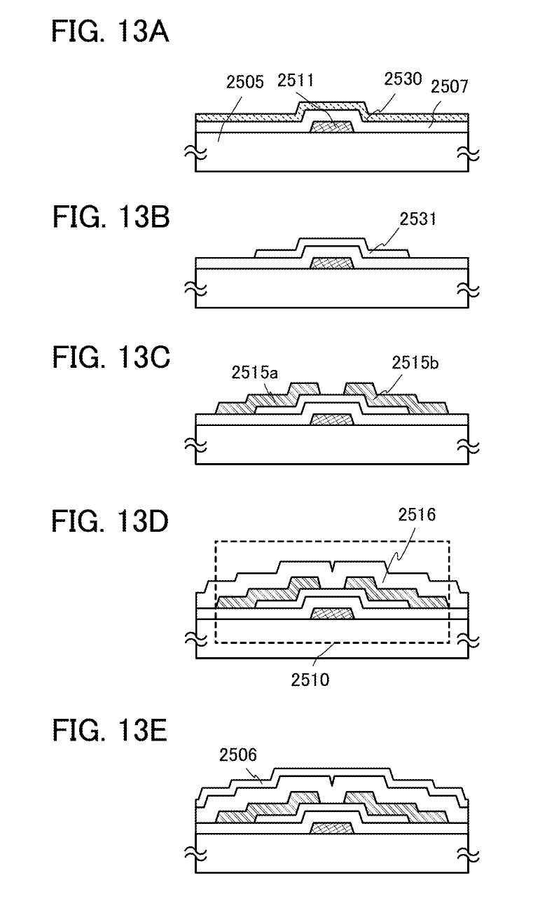

In this embodiment, an example of a transistor including an oxide semiconductor layer and an example of a method for manufacturing the transistor including an oxide semiconductor layer will be described in detail with reference to FIGS. 13A to 13E.

FIGS. 13A to 13E illustrate an example of a cross-sectional structure of a transistor. A transistor 2510 illustrated in FIGS. 13A to 13E is an inverted staggered thin film transistor having a bottom-gate structure, which is similar to the transistor 2410 illustrated in FIG. 12A.

An oxide semiconductor used for a semiconductor layer in this embodiment is an i-type (intrinsic) oxide semiconductor or a substantially i-type (intrinsic) oxide semiconductor. The i-type (intrinsic) oxide semiconductor or substantially i-type (intrinsic) oxide semiconductor is obtained in such a manner that hydrogen, which serves as a donor, is removed from an oxide semiconductor as much as possible, and the oxide semiconductor is highly purified so as to contain as few impurities that are not main components of the oxide semiconductor as possible. In other words, the oxide semiconductor according to one embodiment of the present invention has a feature in that it is made to be an i-type (intrinsic) semiconductor or made to be close thereto not by addition of an impurity but by being highly purified by removal of an impurity such as hydrogen or water as much as possible. Accordingly, the oxide semiconductor layer included in the transistor 2510 is an oxide semiconductor layer which is highly purified and made to be electrically i-type (intrinsic).

In addition, the highly purified oxide semiconductor includes extremely few carriers (close to zero), and the carrier concentration is lower than 1×10¹⁴/cm³, preferably lower than 1×10¹²/cm³, more preferably lower than 1×10¹¹/cm³.

Since the number of carriers in the oxide semiconductor is extremely small, off-state current can be reduced in the transistor. It is preferable that off-state current be as small as possible.

Specifically, in the transistor including the oxide semiconductor layer, the off-state current density per micrometer of channel width at room temperature can be less than or equal to 10 aA/μm (1×10⁻¹⁷ A/μm), further less than or equal to 1 aA/μm (1×10⁻¹⁸ A/μm), or still further less than or equal to 10 zA/μm (1×10⁻²⁰ A/μm).

When a transistor whose current value in an off state (off-state current value) is extremely small is used as the transistor in the pixel portion of Embodiment 1, the number of times of refresh operation can be small in displaying a still image.

In addition, in the transistor 2510 including the oxide semiconductor layer, the temperature dependence of on-state current is hardly observed, and off-state current remains extremely small.

A process of manufacturing the transistor 2510 over a substrate 2505 is described below with reference to FIGS. 13A to 13E.

First, a conductive film is formed over the substrate 2505 having an insulating surface, and then, a gate electrode layer 2511 is formed through a first photolithography step and an etching step. Note that a resist mask may be formed by an inkjet method. Formation of the resist mask by an inkjet method needs no photomask; thus, manufacturing cost can be reduced.

As the substrate 2505 having an insulating surface, a substrate similar to the substrate 2400 described in Embodiment 3 can be used. In this embodiment, a glass substrate is used as the substrate 2505.

An insulating film serving as a base film may be provided between the substrate 2505 and the gate electrode layer 2511. The base film has a function of preventing diffusion of an impurity element from the substrate 2505, and can be formed to have a single-layer structure or a stacked-layer structure using one or more of a silicon nitride film, a silicon oxide film, a silicon nitride oxide film, and a silicon oxynitride film.

The gate electrode layer 2511 can be formed to have a single-layer structure or a stacked-layer structure using a metal material such as molybdenum, titanium, tantalum, tungsten, aluminum, copper, neodymium, or scandium, or an alloy material which contains any of these materials as its main component.

Next, a gate insulating layer 2507 is formed over the gate electrode layer 2511. The gate insulating layer 2507 can be formed to have a single-layer structure or a stacked-layer structure using a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, or a hafnium oxide layer by a plasma CVD method, a sputtering method, or the like.

For the oxide semiconductor in this embodiment, an oxide semiconductor which is made to be an i-type semiconductor or a substantially i-type semiconductor by removal of an impurity is used. Such a highly-purified oxide semiconductor is highly sensitive to an interface state or interface charge; thus, an interface between the oxide semiconductor layer and the gate insulating layer is important. For that reason, the gate insulating layer that is to be in contact with a highly-purified oxide semiconductor needs to have high quality.

For example, high-density plasma CVD using microwaves (e.g., a frequency of 2.45 GHz) is preferable because a dense high-quality insulating layer having high withstand voltage can be formed. The highly-purified oxide semiconductor and the high-quality gate insulating layer are in close contact with each other, whereby the interface state can be reduced and favorable interface characteristics can be obtained.

Needless to say, another film formation method such as a sputtering method or a plasma CVD method can be employed as long as the method enables formation of a high-quality insulating layer as a gate insulating layer. Moreover, it is possible to use as the gate insulating layer an insulating layer whose quality and characteristics of an interface with an oxide semiconductor are improved by heat treatment performed after the formation of the insulating layer. In any case, an insulating layer that can reduce interface state density with an oxide semiconductor to form a favorable interface, as well as having favorable film quality as the gate insulating layer, is formed.

Further, in order that hydrogen, hydroxyl, and moisture might be contained in the gate insulating layer 2507 and an oxide semiconductor film 2530 as little as possible, it is preferable that the substrate 2505 over which the gate electrode layer 2511 is formed or the substrate 2505 over which layers up to the gate insulating layer 2507 are formed be preheated in a preheating chamber of a sputtering apparatus as pretreatment for deposition of the oxide semiconductor film 2530 so that impurities such as hydrogen and moisture adsorbed to the substrate 2505 are eliminated and evacuated. As an evacuation unit provided for the preheating chamber, a cryopump is preferable. Note that this preheating treatment can be omitted. This preheating treatment may be similarly performed on the substrate 2505 over which layers up to a source electrode layer 2515a and a drain electrode layer 2515b are formed before formation of an insulating layer 2516.

Next, the oxide semiconductor film 2530 having a thickness of greater than or equal to 2 nm and less than or equal to 200 nm, preferably greater than or equal to 5 nm and less than or equal to 30 nm is formed over the gate insulating layer 2507 (see FIG. 13A).

Note that before the oxide semiconductor film 2530 is formed by a sputtering method, powder substances (also referred to as particles or dust) attached on a surface of the gate insulating layer 2507 are preferably removed by reverse sputtering in which an argon gas is introduced and plasma is generated. The reverse sputtering refers to a method in which voltage is applied to a substrate side with the use of an RF power source in an argon atmosphere and ionized argon collides with the substrate so that a substrate surface is modified. Note that instead of an argon atmosphere, a nitrogen atmosphere, a helium atmosphere, an oxygen atmosphere, or the like may be used.

As an oxide semiconductor used for the oxide semiconductor film 2530, an oxide semiconductor described in Embodiment 3, such as a four-component metal oxide, a three-component metal oxide, a two-component metal oxide, an In—O-based metal oxide, a Sn—O-based metal oxide, or a Zn—O-based metal oxide can be used. Further, Si may be contained in the above oxide semiconductor. In this embodiment, the oxide semiconductor film 2530 is formed by a sputtering method with the use of an In—Ga—Zn—O-based metal oxide target. A cross-sectional view at this stage corresponds to FIG. 13A. Alternatively, the oxide semiconductor film 2530 can be formed by a sputtering method in a rare gas (typically, argon) atmosphere, an oxygen atmosphere, or a mixed atmosphere containing a rare gas (typically, argon) and oxygen.

As a target for forming the oxide semiconductor film 2530 by a sputtering method, for example, a metal oxide having a composition ratio of In₂O₃:Ga₂O₃:ZnO=1:1:1 [molar ratio] or the like can be used. Alternatively, a metal oxide having a composition ratio of In₂O₃:Ga₂O₃:ZnO=1:1:2 [molar ratio] may be used. The filling rate of the oxide target is higher than or equal to 90% and lower than or equal to 100%, preferably, higher than or equal to 95% and lower than or equal to 99.9%. With the use of the metal oxide target with high filling rate, the deposited oxide semiconductor film has high density.

It is preferable that a high-purity gas from which an impurity such as hydrogen, water, hydroxyl, or hydride is removed be used as the sputtering gas for the deposition of the oxide semiconductor film 2530.

The substrate is held in a deposition chamber under reduced pressure, and the substrate temperature is set to higher than or equal to 100° C. and lower than or equal to 600° C., preferably higher than or equal to 200° C. and lower than or equal to 400° C. Deposition is performed while the substrate is heated, whereby the impurity concentration in the oxide semiconductor film formed can be reduced. Moreover, damage to the oxide semiconductor film due to sputtering is reduced. The oxide semiconductor film 2530 is formed over the substrate 2505 in such a manner that a sputtering gas from which hydrogen and moisture have been removed is introduced into the deposition chamber while moisture remaining therein is removed, and the above-described target is used. In order to remove moisture remaining in the deposition chamber, an entrapment vacuum pump, for example, a cryopump, an ion pump, or a titanium sublimation pump is preferably used. Further, an evacuation unit may be a turbo molecular pump provided with a cold trap. In the deposition chamber which is evacuated with the cryopump, a hydrogen atom, a compound containing a hydrogen atom such as water (H₂O), (more preferably, also a compound containing a carbon atom), and the like are removed, whereby the impurity concentration in the oxide semiconductor film formed in the deposition chamber can be reduced.

As one example of the deposition condition, the distance between the substrate and the target is 100 mm, the pressure is 0.6 Pa, the direct-current (DC) power source is 0.5 kW, and the atmosphere is an oxygen atmosphere (the proportion of the oxygen flow rate is 100%). Note that a pulse direct-current power source is preferable because powder substances (also referred to as particles or dust) generated in deposition can be reduced and the film thickness can be uniform.

Then, the oxide semiconductor film 2530 is processed into an island-shaped oxide semiconductor layer by a second photolithography step and an etching step. A resist mask for forming the island-shaped oxide semiconductor layer may be formed by an inkjet method. Formation of the resist mask by an inkjet method needs no photomask; thus, manufacturing cost can be reduced.

In the case where a contact hole is formed in the gate insulating layer 2507, a step of forming the contact hole can be performed at the same time as processing of the oxide semiconductor film 2530.

Note that the etching of the oxide semiconductor film 2530 may be dry etching, wet etching, or both dry etching and wet etching. As an etchant used for wet etching of the oxide semiconductor film 2530, for example, a mixed solution of phosphoric acid, acetic acid, and nitric acid, or the like can be used. Alternatively, ITO-07N (produced by KANTO CHEMICAL CO., INC.) may be used.

Next, the oxide semiconductor layer is subjected to first heat treatment. The oxide semiconductor layer can be dehydrated or dehydrogenated by this first heat treatment. The temperature of the first heat treatment is higher than or equal to 400° C. and lower than or equal to 750° C., or higher than or equal to 400° C. and lower than the strain point of the substrate. Here, the substrate is introduced into an electric furnace which is one of heat treatment apparatuses, and heat treatment is performed on the oxide semiconductor layer at 450° C. for one hour in a nitrogen atmosphere; thus, an oxide semiconductor layer 2531 is formed (see FIG. 13B).

Note that a heat treatment apparatus is not limited to an electrical furnace, and may be provided with a device for heating an object to be processed by heat conduction or heat radiation from a heating element such as a resistance heating element. For example, a rapid thermal annealing (RTA) apparatus such as a gas rapid thermal annealing (GRTA) apparatus or a lamp rapid thermal annealing (LRTA) apparatus can be used. An LRTA apparatus is an apparatus for heating an object to be processed by radiation of light (an electromagnetic wave) emitted from a lamp such as a halogen lamp, a metal halide lamp, a xenon arc lamp, a carbon arc lamp, a high pressure sodium lamp, or a high pressure mercury lamp. A GRTA apparatus is an apparatus for heat treatment using a high-temperature gas. As the high temperature gas, an inert gas which does not react with an object to be processed by heat treatment, such as nitrogen or a rare gas like argon, is used.

For example, as the first heat treatment, GRTA by which the substrate is moved into an inert gas heated to a temperature as high as 650° C. to 700° C., heated for several minutes, and moved out of the inert gas heated to the high temperature may be performed.

Note that in the first heat treatment, it is preferable that water, hydrogen, and the like be not contained in the atmosphere of nitrogen or a rare gas such as helium, neon, or argon. It is preferable that the purity of nitrogen or a rare gas such as helium, neon, or argon which is introduced into a heat treatment apparatus be 6N (99.9999%) or higher, preferably 7N (99.99999%) or higher (that is, the impurity concentration is 1 ppm or lower, preferably 0.1 ppm or lower).

Further, after the oxide semiconductor layer is heated through the first heat treatment, a high-purity oxygen gas, a high-purity N₂O gas, or an ultra-dry air (the dew point is lower than or equal to −40° C., preferably lower than or equal to −60° C.) may be introduced into the same furnace. The purity of an oxygen gas or an N₂O gas which is introduced into the heat treatment apparatus is preferably 6N or higher, more preferably 7N or higher (that is, the impurity concentration in the oxygen gas or the N₂O gas is 1 ppm or less, preferably 0.1 ppm or less). It is preferable that water, hydrogen, and the like be not contained in these gases in particular. By the action of the oxygen gas or the N₂O gas, oxygen which is a main component of the oxide semiconductor and which has been eliminated at the same time as the step for removing impurities by dehydration or dehydrogenation can be supplied. Through this step, the oxide semiconductor layer can be highly purified and made to be an electrically i-type (intrinsic) oxide semiconductor.

The first heat treatment for the oxide semiconductor layer can be performed on the oxide semiconductor film 2530 that has not been processed into the island-shaped oxide semiconductor layer. In that case, the substrate is taken out of the heat apparatus after the first heat treatment, and then a photolithography step is performed.

Note that the first heat treatment may be performed at any of the following timings in addition to the above timing as long as it is performed after deposition of the oxide semiconductor layer: after the source electrode layer and the drain electrode layer are formed over the oxide semiconductor layer; and after the insulating layer is formed over the source electrode layer and the drain electrode layer.

Further, in the case where a contact hole is formed in the gate insulating layer 2507, the formation of the contact hole may be performed either before or after the first heat treatment is performed on the oxide semiconductor film 2530.

Further, an oxide semiconductor layer formed in the following manner may also be used: an oxide semiconductor is deposited twice, and heat treatment is performed thereon twice. Through such steps, a crystal region (a single crystal region) which is c-axis-aligned perpendicularly to a surface of the film and has a large thickness can be formed without depending on a base component. For example, a first oxide semiconductor film with a thickness of greater than or equal to 3 nm and less than or equal to 15 nm is deposited, and first heat treatment is performed in a nitrogen atmosphere, an oxygen atmosphere, a rare gas atmosphere, or a dry air atmosphere at a temperature higher than or equal to 450° C. and lower than or equal to 850° C., preferably higher than or equal to 550° C. and lower than or equal to 750° C., so that a first oxide semiconductor film having a crystal region (including a plate-like crystal) in a region including a surface is formed. Then, a second oxide semiconductor film which has a larger thickness than the first oxide semiconductor film is formed, and second heat treatment is performed at a temperature higher than or equal to 450° C. and lower than or equal to 850° C., preferably higher than or equal to 600° C. and lower than or equal to 700° C. Through such steps, in the entire second oxide semiconductor film, crystal growth can proceed from the lower part to the upper part using the first oxide semiconductor layer as a seed crystal, whereby an oxide semiconductor layer having a thick crystal region can be formed.

Next, a conductive film to be the source electrode layer and the drain electrode layer (including a wiring formed from the same layer as the source electrode layer and the drain electrode layer) is formed over the gate insulating layer 2507 and the oxide semiconductor layer 2531. As the conductive film serving as the source electrode layer and the drain electrode layer, the material used for the source electrode layer 2405a and the drain electrode layer 2405b which is described in Embodiment 3 can be used.

A resist mask is formed over the conductive film in a third photolithography step and selective etching is performed, so that the source electrode layer 2515a and the drain electrode layer 2515b are formed. Then, the resist mask is removed (see FIG. 13C).

Ultraviolet light, KrF laser light, or ArF laser light is preferably used for light exposure for forming the resist mask in the third photolithography step. The channel length L of the transistor that is completed later is determined by a distance between bottom end portions of the source electrode layer and the drain electrode layer, which are adjacent to each other over the oxide semiconductor layer 2531. In the case where the channel length L is less than 25 nm, the light exposure at the time of the formation of the resist mask in the third photolithography step may be performed using extreme ultraviolet light having an extremely short wavelength of several nanometers to several tens of nanometers. Light exposure with extreme ultraviolet light leads to a high resolution and a large depth of focus. Thus, the channel length L of the transistor to be completed later can be greater than or equal to 10 nm and less than or equal to 1000 nm and the operation speed of a circuit can be increased, and furthermore the off-state current is extremely small, and thus lower power consumption can be achieved.

In order to reduce the number of photomasks and steps in the photolithography step, the etching step may be performed using a resist mask formed by a multi-tone mask. A resist mask formed using a multi-tone mask through which light is transmitted to have a plurality of intensities has a plurality of thicknesses. Since the resist mask can be changed in shape by ashing, a plurality of etching steps through which different patterns can be provided by one photolithography step can be performed. Thus, the number of light-exposure masks can be reduced and the number of corresponding photolithography steps can also be reduced, whereby simplification of a process can be realized.

Note that it is preferable that etching conditions be optimized so as not to etch and divide the oxide semiconductor layer 2531 when the conductive film is etched. However, it is difficult to obtain etching conditions in which only the conductive film is etched and the oxide semiconductor layer 2531 is not etched at all. In some cases, only part of the oxide semiconductor layer 2531 is etched to be an oxide semiconductor layer having a groove portion (a recessed portion) when the conductive film is etched.

In this embodiment, a Ti film is used as the conductive film and an In—Ga—Zn—O-based oxide is used as the oxide semiconductor layer 2531; thus, an ammonia hydrogen peroxide solution (a mixed solution of ammonia, water, and a hydrogen peroxide solution) may be used as an etchant.

Next, the insulating layer 2516 serving as a protective insulating film is formed in contact with part of the oxide semiconductor layer. Before the formation of the insulating layer 2516, plasma treatment using a gas such as N₂O, N₂, or Ar may be performed to remove water or the like adsorbed on an exposed surface of the oxide semiconductor layer.

The insulating layer 2516 can be formed to a thickness of at least 1 nm by a method through which an impurity such as water or hydrogen does not enter the insulating layer 2516, such as a sputtering method, as appropriate. When hydrogen is contained in the insulating layer 2516, hydrogen might enter the oxide semiconductor layer or oxygen might be extracted from the oxide semiconductor layer by hydrogen. In such a case, the resistance of the oxide semiconductor layer on the backchannel side might be decreased (the oxide semiconductor layer on the backchannel side might have n-type conductivity) and a parasitic channel might be formed. Therefore, it is important to form the insulating layer 2516 by a method through which hydrogen and an impurity containing hydrogen are not contained therein.

In this embodiment, a silicon oxide film is formed to a thickness of 200 nm as the insulating layer 2516 by a sputtering method. The substrate temperature in film formation may be higher than or equal to room temperature and lower than or equal to 300° C. and in this embodiment, is 100° C. The silicon oxide film can be formed by a sputtering method in a rare gas (typically, argon) atmosphere, an oxygen atmosphere, or a mixed atmosphere containing a rare gas and oxygen. As a target, a silicon oxide target or a silicon target may be used. For example, the silicon oxide film can be formed using a silicon target by a sputtering method in an atmosphere containing oxygen. For the insulating layer 2516 which is formed in contact with the oxide semiconductor layer, an inorganic insulating film that hardly contains impurities such as moisture, a hydrogen ion, and OH⁻ and that blocks entry of such impurities from the outside is preferably used. Typically, a silicon oxide film, a silicon oxynitride film, an aluminum oxide film, an aluminum oxynitride film, or the like can be used.

In order to remove moisture remaining in the deposition chamber of the insulating layer 2516 at the same time as deposition of the oxide semiconductor film 2530, an entrapment vacuum pump (such as a cryopump) is preferably used. When the insulating layer 2516 is deposited in the deposition chamber evacuated using a cryopump, the impurity concentration in the insulating layer 2516 can be reduced. In addition, as an evacuation unit for removing moisture remaining in the deposition chamber of the insulating layer 2516, a turbo molecular pump provided with a cold trap may be used.

It is preferable that a high-purity gas from which an impurity such as hydrogen, water, hydroxyl, or hydride is removed be used as the sputtering gas for the deposition of the insulating layer 2516.

Next, second heat treatment (preferably at higher than or equal to 200° C. and lower than or equal to 400° C., for example, higher than or equal to 250° C. and lower than or equal to 350° C.) is performed in an inert gas atmosphere or an oxygen gas atmosphere. For example, the second heat treatment is performed at 250° C. for 1 hour in a nitrogen atmosphere. In the second heat treatment, part of the oxide semiconductor layer (a channel formation region) is heated in the state where it is in contact with the insulating layer 2516.

Through the above steps, oxygen which is one of main components of an oxide semiconductor and which is reduced together with an impurity such as hydrogen, water, hydroxyl, or hydride (also referred to as a hydrogen compound) through the first heat treatment performed on the oxide semiconductor film can be supplied. Thus, the oxide semiconductor layer is highly purified and is made to be an electrically i-type (intrinsic) semiconductor.

Through the above steps, the transistor 2510 is formed (see FIG. 13D).

When a silicon oxide layer having a lot of defects is used as the oxide insulating layer, an impurity such as hydrogen, water, hydroxyl, or hydride contained in the oxide semiconductor layer can be diffused into the silicon oxide layer through the heat treatment performed after the silicon oxide layer is formed. That is, the impurity in the oxide semiconductor layer can be further reduced.

A protective insulating layer 2506 may be further formed over the insulating layer 2516. For example, a silicon nitride film is formed by an RF sputtering method. The RF sputtering method is preferable as a formation method of the protective insulating layer because it achieves high mass productivity. An inorganic insulating film which hardly contains an impurity such as moisture and can prevents entry of the impurity from the outside, such as a silicon nitride film or an aluminum nitride film, is preferably used as the protective insulating layer. In this embodiment, the protective insulating layer 2506 is formed using a silicon nitride film (see FIG. 13E).

A silicon nitride film used for the protective insulating layer 2506 is formed in such a manner that the substrate 2505 over which layers up to the insulating layer 2516 are formed is heated to higher than or equal to 100° C. and lower than or equal to 400° C., a sputtering gas containing high-purity nitrogen from which hydrogen and water are removed is introduced, and a target of silicon is used. Also in that case, the protective insulating layer 2506 is preferably formed while moisture remaining in the treatment chamber is removed, similarly to the insulating layer 2516.

After the protective insulating layer is formed, heat treatment may be further performed at higher than or equal to 100° C. and lower than or equal to 200° C. for longer than or equal to 1 hour and shorter than or equal to 30 hours in air. This heat treatment may be performed at a fixed temperature. Alternatively, the following change in temperature is set as one cycle and may be repeated plural times: the temperature is increased from room temperature to a heating temperature and then decreased to room temperature.

As described above, with the use of the transistor including a highly-purified oxide semiconductor layer manufactured using this embodiment, the current value in an off state (off-state current value) can be further reduced. Therefore, the potential of a pixel in a display device can be held for a long period of time and the frequency of refresh operation can be extremely low; thus, an effect of suppressing power consumption can be enhanced.

In addition, since the transistor including a highly-purified oxide semiconductor layer has high field-effect mobility, high-speed operation is possible. Thus, with the use of the transistor for a pixel portion of a liquid crystal display device, a high-quality image can be provided. Further, with the use of the transistor, a driver circuit portion can be formed over the same substrate as the pixel portion, and the number of components of the liquid crystal display device can be reduced.

This embodiment can be implemented in appropriate combination with any of the structures described in the other embodiments.

### Embodiment 5

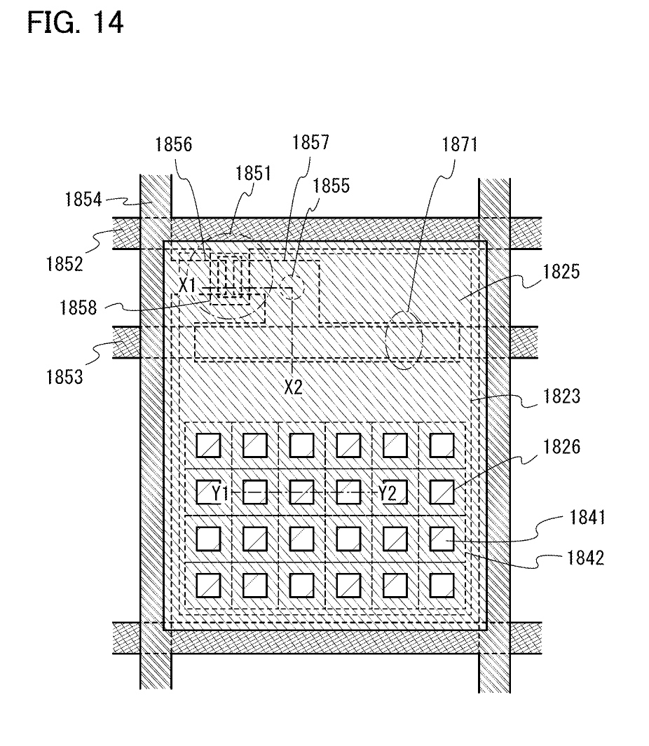

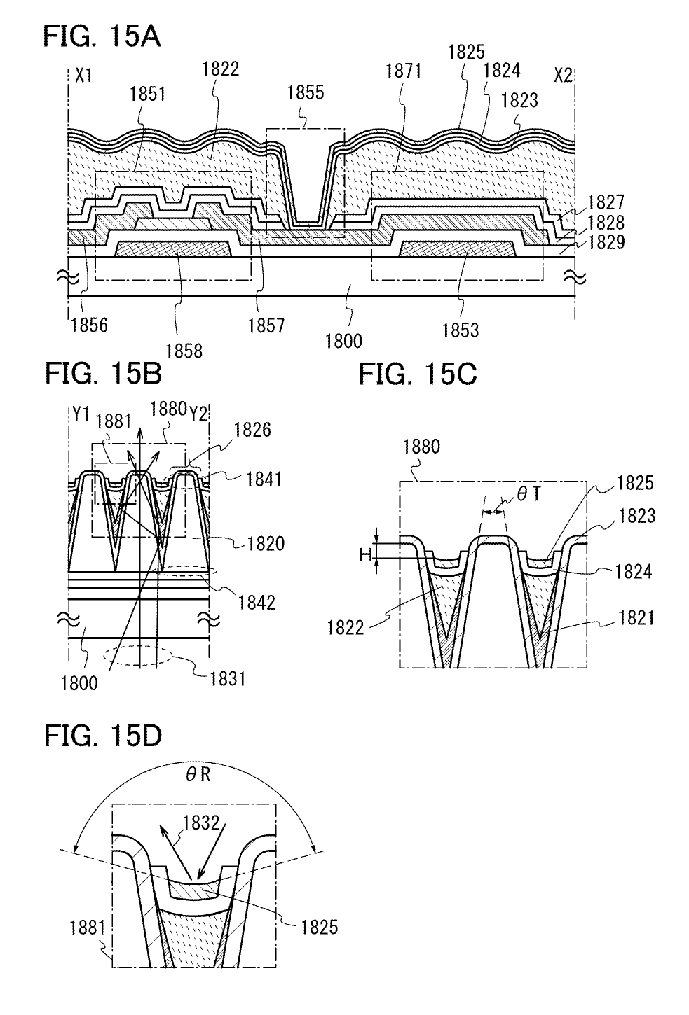

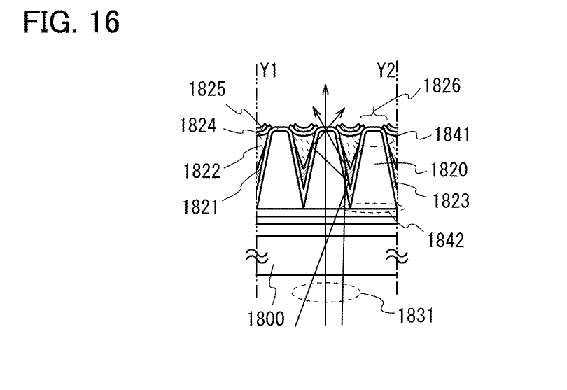

In this embodiment, a pixel structure which enables increase in the amount of reflected light and transmitted light per one pixel in a semi-transmissive liquid crystal display device will be described with reference to FIG. 14, FIGS. 15A to 15D, and FIG. 16.

FIG. 14 illustrates a plan structure of a pixel described in this embodiment. FIGS. 15A and 15B illustrate cross-sectional structures of a portion along X1-X2 and a portion along Y1-Y2 respectively, denoted by dashed lines in FIG. 14. In a pixel described in this embodiment, over a substrate 1800, a light-transmitting conductive layer 1823, an insulating film 1824, and a reflective electrode 1825 are stacked in a pixel electrode portion, and the light-transmitting conductive layer 1823 and the reflective electrode 1825 are connected to a drain electrode 1857 of a transistor 1851 in a contact hole 1855 provided in an insulating film 1827, an insulating film 1828, and an organic region film 1822. The drain electrode 1857 overlaps with a capacitor wiring 1853 with a gate insulating film 1829 positioned therebetween to form a storage capacitor 1871 (see FIG. 15A).

A gate electrode 1858 of the transistor 1851 is connected to a wiring 1852, and a source electrode 1856 of the transistor 1851 is connected to a wiring 1854. The transistor described in any of the other embodiments can be used as the transistor 1851.

External light is reflected by the reflective electrode 1825, so that the pixel electrode can function as a pixel electrode of a reflective liquid crystal display device. The reflective electrode 1825 is provided with a plurality of opening portions 1826. In the opening portion 1826, the reflective electrode 1825 does not exist, and a structure body 1820 and the light-transmitting conductive layer 1823 are projected. Light from a backlight is transmitted through the opening portion 1826, so that the pixel electrode can function as a pixel electrode of a transmissive liquid crystal display device.

FIG. 16 is a cross-sectional view illustrating an example different from FIG. 15B, which is one embodiment of the present invention having a structure in which the structure body 1820 and the light-transmitting conductive layer 1823 are not projected in the opening portion 1826. In FIG. 15B, a backlight exit 1841 and the opening portion 1826 have almost the same size, whereas in FIG. 16, the backlight exit 1841 and the opening portion 1826 have different sizes and different distances from a backlight entrance 1842. Therefore, the area of a transmissive region can be made larger in FIG. 15B than that in FIG. 16, and it can be said that the cross-sectional shape in FIG. 15B is preferable.

The structure body 1820 is formed in a lower layer of the opening portion 1826 so as to overlap with the opening portion 1826. FIG. 15B is a cross-sectional view of the portion along Y1-Y2 in FIG. 14, which illustrates the structures of the pixel electrode and the structure body 1820. FIG. 15C is an enlarged view of a portion 1880, and FIG. 15D is an enlarged view of a portion 1881.

Reflected light 1832 is external light reflected by the reflective electrode 1825. The top surface of the organic resin film 1822 is a curving surface with an uneven shape. By reflecting the curving surface with an uneven shape on the reflective electrode 1825, the area of the reflective region can be increased, and reflection of an object other than the displayed image is reduced so that visibility of the displayed image can be improved. In the cross-sectional shape, the angle θR at a point where the reflective electrode 1825 having a curving surface is most curved, formed by two inclined planes facing each other may be greater than or equal to 90°, preferably greater than or equal to 100° and less than or equal to 120° (see FIG. 15D).

The structure body 1820 includes the backlight exit 1841 on the opening portion 1826 side and the backlight entrance 1842 on a backlight (not illustrated) side. The upper portion of the structure body 1820 is positioned above the surface of the reflective electrode 1825 and protrudes from the end portion of the reflective electrode 1825. The distance H between the top surface of the structure body 1820 and the upper end portion of the reflective electrode is greater than or equal to 0.1 μm and less than or equal to 3 μm, preferably greater than or equal to 0.3 μm and less than or equal to 2 μm. The backlight entrance 1842 is formed so as to have a larger area than the backlight exit 1841. A reflective layer 1821 is formed on the side surfaces of the structure body 1820 (surfaces on which neither the backlight exit 1841 nor the backlight entrance 1842 is formed). The structure body 1820 can be formed using a material having a light-transmitting property such as silicon oxide (SiOₓ), silicon nitride (SiNₓ), or silicon oxynitride (SiNO). The reflective layer 1821 can be formed using a material with high light reflectance such as aluminum (Al) or silver (Ag).

Transmitted light 1831 emitted from the backlight enters the structure body 1820 through the backlight entrance 1842. Some of the incident transmitted light 1831 is directly emitted from the backlight exit 1841, some is reflected toward the backlight exit 1841 by the reflective layer 1821, and some is further reflected to return to the backlight entrance 1842.

At this time, according to the shape of a cross section of the structure body 1820 through the backlight exit 1841 to the backlight entrance 1842, side surfaces on right and left facing each other are inclined surfaces. The angle θT formed by the side surfaces is made to be less than 90°, preferably greater than or equal to 10° and less than or equal to 60°, so that the transmitted light 1831 incident from the backlight entrance 1842 can be guided efficiently to the backlight exit 1841.

In a conventional semi-transmissive liquid crystal display device, when the electrode area functioning as a reflective electrode in a pixel electrode portion is SR and the electrode area functioning as a transmissive electrode in the pixel electrode portion (the area of the opening portion 1826) is ST, the proportion of the total area of both electrodes is 100% (SR+ST=100%). In a semi-transmissive liquid crystal display device having a pixel structure described in this embodiment, since the electrode area ST functioning as a transmissive electrode corresponds to the area of the backlight entrance 1842, the amount of transmitted light can be increased without increasing the area of the opening portion 1826 or the luminance of the backlight. In other words, the proportion of the total of the electrode area SR and the electrode area ST in appearance can be 100% or more.

According to this embodiment, a semi-transmissive liquid crystal display device with bright and high-quality display can be obtained without increasing power consumption.

This embodiment can be implemented in appropriate combination with any of the structures described in the other embodiments.

### Embodiment 6

In this embodiment, an example of an electronic device including the liquid crystal display device described in any of the above embodiments will be described.

Note that this embodiment describes one example to which a display device and a driving method thereof in one embodiment of the present invention can be applied. One embodiment of the present invention can also be applied to other display devices having a function of displaying a still image.

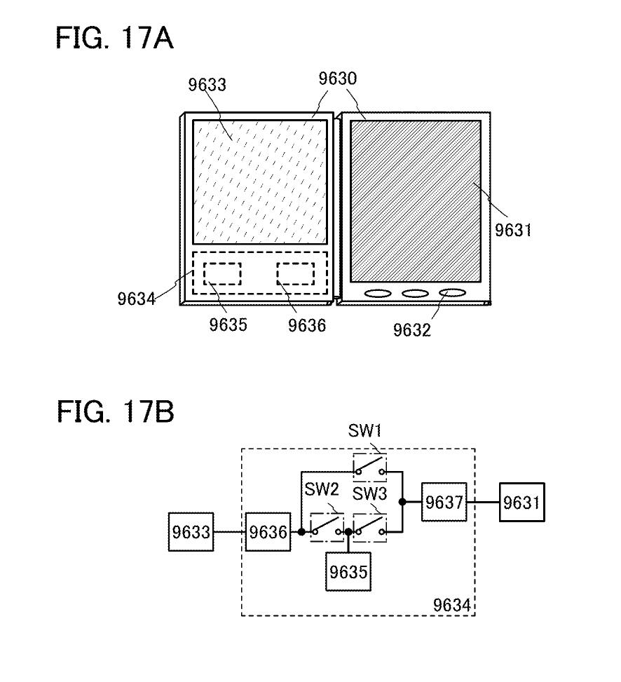

FIG. 17A illustrates an electronic book reader (also referred to as an e-book reader) that can include housings 9630, a display portion 9631, operation keys 9632, a solar battery 9633, and a charge and discharge control circuit 9634. The electronic book reader is provided with the solar battery 9633 and a display panel so that the solar battery 9633 and the display panel can be opened and closed freely. In the electronic book reader, electric power from the solar battery is supplied to the display panel, a backlight portion, or an image processing circuit. The electronic book reader in FIG. 17A can have a function of displaying a variety of information (e.g., a still image, a moving image, and a text image) on the display portion, a function of displaying a calendar, a date, the time, and the like on the display portion, a function of operating or editing the information displayed on the display portion, a function of controlling processing by various kinds of software (programs), and the like. Note that in FIG. 17A, a structure including a battery 9635 and a DCDC converter (hereinafter abbreviated as a converter 9636) is illustrated as an example of the charge and discharge control circuit 9634.

When a semi-transmissive liquid crystal display device is used as the display portion 9631, in the case where use under a relatively bright condition is assumed, the structure illustrated in FIG. 17A is preferable because power generation by the solar battery 9633 and charge in the battery 9635 are efficiently performed. Note that a structure in which the solar battery 9633 is provided on each of a surface and a rear surface of the housing 9630 is preferable in order to charge the battery 9635 efficiently. Note that it is advantageous to use a lithium ion battery as the battery 9635 because reduction in size can be achieved, for example.

The structure and the operation of the charge and discharge control circuit 9634 illustrated in FIG. 17A are described with reference to a block diagram in FIG. 17B. The solar battery 9633, the battery 9635, the converter 9636, a converter 9637, switches SW1 to SW3, and the display portion 9631 are shown in FIG. 17B, and the battery 9635, the converter 9636, the converter 9637, and the switches SW1 to SW3 correspond to the charge and discharge control circuit 9634.

First, an example of operation in the case where electric power is generated by the solar battery 9633 using external light is described. The voltage of electric power generated by the solar battery is raised or lowered by the converter 9636 so that the electric power has a voltage for charging the battery 9635. Then, when the electric power from the solar battery 9633 is used for the operation of the display portion 9631, the switch SW1 is turned on and the voltage of the electric power is raised or lowered by the converter 9637 so as to be a voltage needed for the display portion 9631. In addition, when display on the display portion 9631 is not performed, the switch SW1 is turned off and the switch SW2 is turned on so that charge of the battery 9635 may be performed.

Next, operation in the case where electric power is not generated by the solar battery 9633 using external light is described. The voltage of electric power accumulated in the battery 9635 is raised or lowered by the converter 9637 by turning on the switch SW3. Then, electric power from the battery 9635 is used for the operation of the display portion 9631.

Note that although the solar battery 9633 is described as an example of a means for charge, charge of the battery 9635 may be performed with another means. In addition, a combination of the solar battery 9633 and another means for charge may be used.

This embodiment can be implemented in appropriate combination with any of the structures described in the other embodiments.

This application is based on Japanese Patent Application serial no. 2010-010473 filed with Japan Patent Office on Jan. 20, 2010, the entire contents of which are hereby incorporated by reference.

1. A display device comprising:
a liquid crystal display panel;
a display control circuit electrically connected to a driver circuit of the liquid crystal display panel;
a monitoring pixel in the liquid crystal display panel; and
an optical sensor electrically connected to the display control circuit, the optical sensor configured to detect an illuminance of the monitoring pixel.

2. The display device according to claim 1,
wherein the optical sensor is configured to detect a light reflected by the monitoring pixel.

3. The display device according to claim 1,
wherein the optical sensor has peak sensitivity to light in a visible-light wavelength range.

4. The display device according to claim 1,
wherein the monitoring pixel is provided outside a display region of the liquid crystal display panel.

5. The display device according to claim 1, further comprising a light guide plate, wherein the optical sensor is configured to detect a light through the light guide plate.

6. The display device according to claim 1,
wherein the monitoring pixel comprises a transistor comprising a semiconductor layer including an oxide semiconductor.

7. An electronic device comprising the display device according to claim 1.

8. A display device comprising:
a liquid crystal display panel;
a display control circuit electrically connected to a driver circuit of the liquid crystal display panel;
a backlight portion electrically connected to the display control circuit;
a monitoring pixel in the liquid crystal display panel; and
an optical sensor electrically connected to the display control circuit, the optical sensor configured to detect a light transmitted through the monitoring pixel.

9. The display device according to claim 8, further comprising a second monitoring pixel in the liquid crystal display panel, wherein the optical sensor is configured to configured to detect a light reflected by the second monitoring pixel.

10. The display device according to claim 9, further comprising a second optical sensor configured to detect a light from an outside of the liquid crystal display panel.

11. The display device according to claim 8,
wherein the optical sensor has peak sensitivity to light in a visible-light wavelength range.

12. The display device according to claim 8,
wherein the monitoring pixel is provided outside a display region of the liquid crystal display panel.

13. The display device according to claim 8, further comprising a light guide plate, wherein the optical sensor is configured to detect a light through the light guide plate.

14. The display device according to claim 8,
wherein the monitoring pixel comprises a transistor comprising a semiconductor layer including an oxide semiconductor.

15. An electronic device comprising the display device according to claim 8.

16. A method for driving a display device, comprising the steps of:
supplying a first potential to a pixel in a display region of a liquid crystal display panel for displaying a first still image;
supplying a second potential to a monitoring pixel in the liquid crystal display panel for displaying a second still image;
detecting at least a light transmitted through a liquid crystal layer of the monitoring pixel from a backlight by an optical sensor; and
supplying a third potential to the pixel in the display region of the liquid crystal display panel and a fourth potential to the monitoring pixel when a rate of change in illuminance of the light detected by the optical sensor reaches a value, so that the first still image and the second still image are kept being displayed.

17. The method for driving a display device according to claim 16,
wherein the third potential supplied to the pixel is gradually increased.

18. A method for driving a display device, comprising the steps of:
supplying a first potential to a pixel in a display region of a liquid crystal display panel for displaying a first still image;
supplying a second potential to a monitoring pixel in the liquid crystal display panel for displaying a second still image;
detecting a first light from an outside of the liquid crystal display panel by a first optical sensor;
detecting at least a second light transmitted through a liquid crystal layer of the monitoring pixel and reflected by an inside portion of the liquid crystal display panel by a second optical sensor; and
calculating a rate of change in illuminance of a reflected light due to a reduction in a pixel potential of the liquid crystal display panel from a difference between a rate of change in illuminance of the first light detected by the first optical sensor and a rate of change in illuminance of the second light detected by the second optical sensor; and
supplying a third potential to the pixel in the display region of the liquid crystal display panel and a fourth potential to the monitoring pixel when the rate of change in illuminance of the reflected light due to the reduction in the pixel potential of the liquid crystal display panel reaches a value, so that the first still image and the second still image are kept being displayed.

19. The method for driving a display device according to claim 18,
wherein the second optical sensor detects the second light transmitted through a liquid crystal layer of a second monitoring pixel and reflected by an electrode of the liquid crystal display panel.

20. The method for driving a display device according to claim 18,
wherein the third potential supplied to the pixel is gradually increased.

21. The method for driving a display device according to claim 18,
wherein the second optical sensor detects a third light transmitted through a second monitoring pixel when a backlight operates for displaying the first still image and the second still image, and
wherein the third potential is supplied to the pixel in the display region of the liquid crystal display panel and the fourth potential is supplied to the monitoring pixel when a rate of change in illuminance of the third light reaches a value, so that the first still image and the second still image are kept being displayed.
